(19) United States
(12) Patent Application Publication
(10) Pub. No.: US 2017/0173573 A1
(43) Pub. Date: Jun. 22, 2017

(54) COPPER NANOPARTICLES FOR DEGRADATION OF POLLUTANTS

(71) Applicant: YEDA RESEARCH AND DEVELOPMENT CO. LTD., Rehovot (IL)

(72) Inventors: Brian BERKOWITZ, Mazkeret Batya (IL); Ishai DROR, Rehovot (IL); Moshe BEN SASSON, Rehovot (IL); Sethu KALIDHASAN, Rehovot (IL)

(21) Appl. No.: 15/403,199

(22) Filed: Jan. 11, 2017

Related U.S. Application Data
(63) Continuation-in-part of application No. PCT/IL2015/050728, filed on Jul. 14, 2015.
(60) Provisional application No. 62/023,976, filed on Jul. 14, 2014.

(51) Int. Cl. B01J 31/16; C08K 3/36; B01J 21/08; C02F 1/78; B01J 35/00; B01J 37/04; B01J 37/00; C02F 1/72; C08K 3/08; B01J 21/16

(52) U.S. Cl. CPC B01J 31/1691; C08K 3/08; C08K 3/36; B01J 21/08; B01J 21/16; B01J 35/0006; B01J 35/0013; B01J 37/04; B01J 37/009; C02F 1/725; C02F 1/722; C02F 1/78; C08K 2003/085; C02F 2101/305

(57) ABSTRACT

The present invention is directed to a degradation composition, methods and kits for degrading organic pollutants comprising reduced copper based nanoparticles-polymer complex (Cu-NPs) and an oxidant.

### CROSS-REFERENCE TO RELATED APPLICATIONS

This application is a Continuation-In-Part of PCT International Application Number PCT/IL2015/050728, International filing date Jul. 14, 2015; claiming priority from U.S. Provisional Application Ser. No. 62/023,976, filed Jul. 14, 2014; both of which are herein incorporated by reference in their entirely.

### FIELD OF THE INVENTION

The present invention is directed to a degradation composite, methods and kits for degrading organic pollutants in advanced oxidation processes (AOPs) comprising reduced copper based nanoparticles-polymer complex (Cu-NPs) and an oxidant.

### BACKGROUND OF THE INVENTION

Global water quality problems (including pollutants such as pharmaceuticals, herbicides, small molecules) require development of efficient and inexpensive technologies. Atrazine (2-chloro-4-ethylamino-6-isopropylamino-s-triazine) is one of the most toxic, heavily used herbicides in the United-States (USA). It has been detected at high concentrations in environmental waters all over Europe and North America. This is due to its extensive use, ability to persist in soils, tendency to travel with water and poor rate of degradation; 3 ppb and 0.1 ppb are the upper limits of atrazine in drinking water in the USA and Europe, respectively. Sedimentation with alum and metal salts, excess lime/soda ash softening, and disinfection by free chlorine were all applied and are ineffective methods.

Another common method for water treatment employs reverse osmosis (RO) and nano filter (NF) membranes; these methods are lacking, being expensive and suffering from membrane fouling due to accumulation of colloidal particles on the membranes.

The most commonly used technology for atrazine removal from water is adsorption by various materials ranging from activated carbon, porous materials, biowastes, clays, etc.

Clays and zeolites are applied as adsorbents for the removal of chemicals (including atrazine) from aqueous stream. Many researchers employed clay minerals modified by a cationic surfactant, dye, metal exchanged clays, polymer-clay, poly-cation clay composites and iron-polymer-clay composites were studied in batch and column experiments for the adsorption of atrazine, but not for degradation.

Similarly, different Fenton's type catalysts with and without solid support were applied for the degradation of chemicals through both chemically and photochemical degradation.

Advanced oxidation processes (AOP) refer to oxidation methods that are based on generation of strong and non-selective free radicals, which attack and destroy anthropogenic organic pollutants. The hydroxyl radical (OH.) is the traditional and predominant radical species employed in AOP, with lesser attention given to other radicals such as sulfate radicals. Essentially, water reacts solely or in combination with UV light, ozone, hydrogen peroxide (H₂O₂) or other methods such as electrochemical or sonochemical, to generate the reactive hydroxyl radicals. In general, catalysts are additionally required as activation agents that facilitate radical formation and improve the oxidation process. Because catalysts may play a key role in oxidation processes, intensive scientific efforts have been dedicated to the development of effective and novel catalytic materials, based mainly on solid mono- or bi-metallic semiconductors [da Silva, A. M. T., Environmental Catalysis from Nano- to Macro-Scale. Mater Tehnol 2009, 43, (3), 113-121; Chan, S. H. S.; Wu, T. Y.; Juan, J. C.; Teh, C. Y., Recent developments of metal oxide semiconductors as photocatalysts in advanced oxidation processes (AOP) for treatment of dye waste-water. J Chem Technol Biot 2011, 86, (9), 1130-1158]. The demonstrated better activity of nano-scale catalysts compared to their micro-macro counterparts [Liou, Y. H.; Lo, S. L.; Lin, C. J., Size effect in reactivity of copper nanoparticles to carbon tetrachloride degradation Water Res 2007, 41, (8), 1705-1712] has prompted a specific focus on the potential of nano-catalysts in AOP.

Chemical degradation can alternatively proceed via hydrolysis. The hydrolysis of atrazine for example results in the formation of hydroxyatrazine. The biotransformation of atrazine to hydroxylatrazine is pH-dependent, hence it could be acid catalyzed (Lei et al; J Environ Sci (China). 2001 13, pages 99-103).

Solid zeolites are used in numerous reactions, such as hydrolysis and other reactions which are acid catalyzed (Corma, A.; Chem. Rev., 1995, 95, pages 559-614). Their vast use in industry is attributed to their unique features such as their well-defined porous structure, crucial for adsorbing numerous compounds such as catalysts and substrates and their acidity that can be tuned (converting them into the H-form, or utilizing inherent lewis acidity of the aluminum cations). Copper based nanoparticles, mostly presented as copper oxide NPs (CuO-NPs), gained scientific interest for diverse applications such as sensors, photovoltaic cells, ink, batteries, degradation of organic contaminants [US Patent Publication 2009/0250404] and selective catalytic reactions of synthesized organic chemicals at high temperature gaseous phase. However, recent reviews about nanotechnology in water treatment processes have barely discussed potential applications of reduced copper based nanoparticles (Cu⁰/Cu(I)-NPs). This limited attention may be explained by a technical difficulty to develop and synthesize stable reduced copper based nanoparticles in aquatic solutions. This instability arises from the strong tendency of copper to be oxidized under ambient conditions, leading to aggregation or dissolution of copper based nanoparticles. Moreover, in water treatment processes such as AOP, it is preferable to use concentrated solutions of copper based nanoparticles to keep the ratio of reactive NP solution vs. treated water volume as low as possible. Therefore, highly dilute solutions as a strategy for maintaining the stability (i.e., lowering the particle collision probability) may not be an advantage here; thus the challenge is exacerbated and requires fabrication of stabilized copper based nanoparticles in highly concentrated solutions.

In general, a CuO powder was fabricated from precipitation of CuₓOH_{y} formed when the pH of Cu salt solution was raised, followed by oxidation of the CuₓOH_{y} precipitate to CuO during heating-drying stage. However, powder nano CuO particles aggregates, and attempts to resuspend the powder in water do not lead to nano-size discrete single particle suspensions. Still, powder commercial CuO coupled with H₂O₂ has demonstrated the ability to oxidize a wide range of aquatic organic contaminants, such as pesticides and polycyclic aromatic hydrocarbons (PAHs) [Ben-Moshe, T.; Dror, I.; Berkowitz, B., Oxidation of organic pollutants in aqueous solutions by nanosized copper oxide catalysts. Appl Catal B-Environ 2009, 85, (3-4), 207-211], brominated flame retardants [Yecheskel, Y.; Dror, I.; Berkowitz, B., Catalytic degradation of brominated flame retardants by copper oxide nanoparticles. Chemosphere 2013, 93, (1), 172-177], and antibiotics [Fink, L.; Dror, I.; Berkowitz, B., Enrofloxacin oxidative degradation facilitated by metal oxide nanoparticles. Chemosphere 2012, 86, (2), 144-149].

### SUMMARY OF THE INVENTION

In one embodiment, this invention is directed to a degradation composite comprising reduced copper(II)-based nanoparticles coordinated to a polymer forming a complex (Cu-NPs), wherein said polymer is an amino based polymer. In another embodiment, the polymer is polyethylenimine and said composite comprises reduced Cu(II)-NPs-polyethylenimine complex. In another embodiment, the composite further comprises a silica based material and said Cu-NPs are incorporated into said silica based material. In another embodiment, the silica based material comprises clay, sand, zeolite or combination thereof.

In one embodiment, this invention is directed to a method of degrading organic pollutants wherein said method comprises contacting a pollutant and a degradation composite comprising reduced copper(II)-based nanoparticle coordinated to a polymer (Cu-NPs), in the presence of an oxidant. In another embodiment, the polymer is an amino based polymer. In another embodiment, the polymer is polyethylenimine and said composite comprises reduced Cu(II)-polyethylenimine complex. In another embodiment, the composite further comprises a silica based material and said Cu-NPs are incorporated into said silica based material. In another embodiment, the silica based material comprises clay, sand, zeolite or combination thereof.

In one embodiment, this invention is directed to a degradation kit comprising:

a. an oxidizing agent; and

b. a degradation composite comprising reduced copper(II)-based nanoparticles wherein said reduced copper(II)-based nanoparticles are coordinated to a polymer forming a complex (Cu-NPs). In another embodiment, the polymer is an amino based polymer. In another embodiment, the polymer is polyethylenimine and said composite comprises reduced Cu(II)-polyethylenimine complex. In another embodiment, the composite further comprises a silica based material and said Cu-NPs are incorporated into said silica based material. In another embodiment, the silica based material comprises clay, sand, zeolite or combination thereof.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A presents UV-Vis absorbance spectra of the different synthesized Cu-NPs of this invention and the commercial CuO suspensions. Four Cu-NPs were synthesized with different concentrations of the stabilized agent polymer (polyethylenimine (PEI)) while maintaining the same copper (50 mM) and NaBH₄ (100 mM) concentrations. Cu-NPs1.5, Cu-NPs4, Cu-NPs7, and Cu-NPs10 refer, respectively, to 1.5, 4, 7, and 10 mL of 1.6 mM PEI solution supplemented in the 50 mL synthesized Cu-NP suspension (equivalent to final concentrations of 48, 128, 224 and 320 μM, respectively, of PEI in the Cu-NP suspension).

FIG. 1B presents size probability functions of the Cu-NPs measured by dynamic light scattering (DLS) and the Cu-NP mean diameters. The Cu-NPs10 has a bimodal size distribution, and two major peaks (particle size distributions) are shown.

FIG. 2A depicts XRD measurements of the dried Cu-NP suspensions and CuO powder. Peaks at angles (2θ) of ˜36.8 or ˜39.1; ˜36.7 or ˜42.5; and 43.5 are an indication of CuO, Cu₂O, and Cu⁰ in the samples, respectively. Before the XRD measurements, the Cu-NP suspensions were carefully dried under anoxic condition to prevent significant change in the oxidation state of the particles. FIGS. 2B, 2C, 2D, and 2E are TEM images of —Cu-NPs1.5, Cu-NPs4, Cu-NPs7, and commercial CuO, respectively.

FIG. 3A presents normalized atrazine degradation rates measured by HPLC. Atrazine solution with: Cu-NPs7+H₂O₂; H₂O₂ only; dissolved Cu²⁺ ions from precursor salt of CuSO₄; Cu-NPs7 only without H₂O₂ and only the PEI polymer. FIG. 3B presents normalized atrazine degradation rates measured by HPLC. Atrazine solutions with different Cu-NPs and commercial CuO with H₂O₂. Experimental conditions: atrazine initial concentration of 19 mg/L, ˜1.5% H₂O₂, were mixed at 350 rpm with concentration equivalent to 0.25 mM Cu of CuSO₄, Cu-NPs, and commercial CuO and PEI at 1.6 μM concentration. The experiments were carried out under ambient temperature.

FIG. 4A depicts qualitative measurement of the total generated free radical indicated by the intensity signal of α-(4-Pyridyl N-oxide)-N-tert-butylnitrone [(POBN)-nitroxyl] radicals in ESR. The radical intensity signals of the different Cu-NPs and commercial CuO during one hour of reaction is presented. Since free radicals have very short life times, they do not accumulate, and each measurement represents a snapshot of the momentary generated radicals. FIG. 4B presents the radical generation during five days (H₂O₂ and Cu-NPs7 concentration of 1.5%, and equivalent to 0.25 mM Cu, respectively).

FIGS. 5A and 5B depict normalized atrazine degradation rates using H₂O₂ and Cu-NPs of this invention for different H₂O₂ concentrations (FIG. 5A) or different Cu-NPs7 concentration (FIG. 5B). Standard experimental conditions: atrazine initial concentration of 19 mg/L, ˜1.5% H₂O₂, and Cu-NPs7 concentration equivalent to 0.25 mM Cu. Mixing speed: 350 rpm. The experiments were carried out under ambient temperature.

FIGS. 6H-6H present versatility of the Cu-NP7 activity toward wide range of prevailed aquatic pollutants. (▪) represents a solution of the contaminant+Cu-NPs7 (concentration equivalent to 0.25 mM Cu)+1.5% H₂O₂, () represents a solution of contaminant with 1.5% H₂O₂ only (no Cu-NPs7). Degradation of: FIG. 6A) bisphenol A (C₀: 50 mgL⁻¹), FIG. 6B) carbamazepine (C₀: 50 mgL⁻¹), FIG. 6C) dibromophenol (DBP, C₀: 50 mgL⁻¹), FIG. 6D) tert-butyl-methyl-ether (MTBE, C₀: 100 mgL⁻¹), FIG. 6E) phenol (C₀: 100 mgL⁻¹), F) naphthalene (C₀: 10 mgL⁻¹), FIG. 6G) rhodamine 6G (C₀: 4 mgL⁻¹), FIG. 6H) xylene (C₀: 50 mgL⁻¹).

FIGS. 7A and 7B present the relative portions of boron (FIG. 7A) and copper (FIG. 7B) that remained after the dialysis stage in the Cu-NPs suspension (i.e. the yield), as was measured by ICP-MS.

FIG. 8 depicts zeta potential of the four synthesized Cu-NP types and the commercial CuO. The suspensions were diluted to achieve particle concentration equivalent to 0.25 mM Cu.

FIG. 9 depicts UV-Vis absorbance spectra of suspensions of Cu-NPs of this invention; of solutions of Cu²⁺ (from precursor Cu(NO₃)₂ salt) and PEI+Cu²⁺. The concentration of copper for both Cu²⁺ ions and Cu-NPs was 0.25 mM, PEI concentration was 1.12 μM.

FIG. 10 depicts atrazine degradation experiments in DI water and in tap water. Atrazine initial concentration: 19 mg L⁻¹, Cu-NPs7 concentration equivalent to 0.25 mM (as Cu), and 1.5% H₂O₂. The experiments were conducted under open atmospheric conditions with stirring velocity of 350 rpm. Each point represents an average of three repetitions.

FIG. 11 presents ESR signals of POBN-nitroxyl radical formed due to reaction with solution of Cu-NPs7 and H₂O₂, Cu⁺ (from Cu(NO₃)₂ precursor salt) and H₂O₂, PEI and H₂O₂ (H₂O₂ concentration was 1.5%. The concentration of copper for both Cu-NPs and Cu⁺ was 0.25 mM, PEI concentration was 1.6 μM).

FIGS. 12A-12E present ESR signals of POBN-nitroxyl radical formed due to reaction with solution of the different Cu-NPs and commercial CuO suspensions (concentration equivalent to 0.25 mM as Cu) with H₂O₂ (1.5%) at different time intervals during one hour reaction time. FIG. 12A) commercial CuO, FIG. 12B) Cu-NPs1.5, FIG. 12C) Cu-NPs4, FIG. 12D) Cu-NPs7, FIG. 12E) Cu-NPs10. The y axis is the signal intensity in arbitrary units with the same scale for all of the graphs.

FIG. 13 presents ESR signals of POBN-nitroxyl radical formed due to reaction with solution of Cu-NPs7 (0.25 mM as Cu) and H₂O₂ (1.5%), 5 times dilution of Cu-NPs7 (0.05 mM as Cu) and 1.5% H₂O₂ suspension, and Cu-NPs7 with 10 times dilution of H₂O₂ (0.15%).

FIGS. 14A-14E depict ESR signals of 5,5-dimethyl-1-pyrroline N-oxide DMPO radical formed due to reaction with solutions of the different Cu-NPs and commercial CuO suspensions (concentration equivalent to 0.25 mM Cu) with H₂O₂ (1.5%), with and without the presence of dimethylsulfoxide (DMSO). FIG. 14A) commercial CuO, FIG. 14B) Cu-NPs1.5, FIG. 14C) Cu-NPs4, FIG. 14D) Cu-NPs7, FIG. 14E) Cu-NPs10. The y axis is the signal intensity in arbitrary units and the same scale is used for all of the graphs. DMSO is a selective hydroxyl scavenger, and hence the elimination of the DMPO radical signal when DMSO was present indicates that the DMPO signals in the absence of DMSO are due to appearance of only hydroxyl radicals and not peroxide radicals.

FIG. 15 depicts ESR signals of POBN-nitroxyl radical formed due to reaction with solution of Cu-NPs7 and H₂O₂ in the first day of reaction, after 7 days of reaction, and after 7 days of reaction and addition of fresh H₂O₂ (1.5%). Recovery of the ESR signal intensity is shown, which demonstrates that the Cu-NPs7 were not poisoned; the lower formation rates of the hydroxyl radicals after several days of reaction are likely due to depletion of H₂O₂.

FIG. 16 depicts atrazine degradation experiments (initial concentration: 20 ppm) with H₂O₂ (1.5%)+Cu-NPs7 (▪, concentration equivalent to 0.25 mM Cu) in light conditions; and H₂O₂+Cu-NPs7 when the vial was covered with aluminum foil to ensure dark conditions (, concentration equivalent to 0.25 mM Cu). There was no significant difference between the activity with or without light.

FIG. 17 depicts atrazine degradation experiment with ozone as oxidant with and without Cu-NPs7 or Cu²⁺ (concentration equivalent to 0.25 mM Cu). The activity of Cu-NPs7 with ozone is clearly demonstrated. When only air was bubbled, without generation of ozone, the atrazine did not disappear. This indicates that the atrazine was chemically degraded when ozone was generated and no volatilization or air stripping of the atrazine occurred.

FIG. 18 presents the effect of NaHCO₃ concentration on the degradation of atrazine using Cu-NPs7 (0.25 mM as Cu) and H₂O₂ (1.5%) of this invention.

FIG. 19 presents the effect of humic acid concentration on the degradation of atrazine using the Cu-NPs7 (0.25 mM as Cu) and H₂O₂ (1.5%) of this invention.

FIG. 20 presents the effect of NaCl concentration on the degradation of atrazine using the Cu-NPs7 (0.25 mM as Cu) and H₂O₂ (1.5%) of this invention. The presence of NaCl significantly accelerated atrazine degradation.

FIG. 21A presents degradation of atrazine with Cu-NPs4 with different concentrations of H₂O₂ after 1 h. FIG. 21B presents degradation of atrazine with Cu-NPs4 with different concentrations of H₂O₂ after 15 h.

FIG. 22A presents the thermogravimetric degradation of PEI-Cu-NPs incorporated into MK10. FIG. 22B presents the thermogravimetric degradation of PEI-Cu-NPs incorporated into sand. FIGS. 22C and 22D present the thermogravimetric analysis of unmodified and modified (FIG. 22C) MK10 vs MK10_PEI, and (FIG. 22D) MK10_PEI vs MK10_PEI-Cu NPs.

FIGS. 23A-23J present scanning electron microscopic (SEM) analysis of PEI-Cu-NPs incorporated into MK10 and sand: SEM images of unmodified MK10 (FIGS. 23A and 23B, having different resolutions), modified MK10 (FIGS. 23C and 23D, having different resolutions), unmodified sand (FIGS. 23E and 23F, having different resolution), modified sand (FIGS. 23G and 23H, having different resolution), elemental mapping of copper on (FIG. 23I) MK10_PEI-Cu NPs, and (FIG. 23J) sand_PEI-Cu NPs.

FIGS. 24A and 24B presents FT-IR spectrum of unmodified and modified by PEI-Cu-NPs (FIG. 24A) MK10, and (FIG. 24B) sand.

FIGS. 25A and 25B presents a comparison of degradation of atrazine, in similar experimental conditions to PEI-Cu-NPs alone, with MK10_PEI-Cu-NPs and sand_PEI-Cu-NPs composites. FIG. 25A presents results after 1 h, FIG. 25B presents results after 15 h.

FIG. 26 presents percentage degradation of atrazine against the change in the concentration PEI-Cu-NPs incorporated into MK10 and sand on atrazine degradation.

FIG. 27 presents the homogeneity of the PEI-Cu-NP incorporation (distribution) on the MK10 and sand. Vertical axis label “D” denotes distribution capacity for atrazine. In this case, it is assumed that the amount of atrazine degraded is similar to that amount adsorbed.

FIGS. 28A-28B present the XRD pattern of (FIG. 28A) modified MK10 by PEI-Cu-NPs and (FIG. 28B) modified sand by PEI-Cu-NPs.

FIGS. 29A-29B present the influence of hydrogen peroxide on degradation of atrazine with modified MK10 by PEI-Cu-NPs and sand at two different equilibrium times: (FIG. 29A) 1 h, and (FIG. 29B) 15 h.

FIG. 30 presents the influence of catalyst dosage on degradation of atrazine. (Conditions: atrazine=20 mg L⁻¹, volume of solution=20 mL, H₂O₂ (30%)=9.8 mM).

FIG. 31 presents the effect of pH (adjusted with H₃PO₄ and K₂HPO₄) on degradation of atrazine.

FIG. 32 presents the structure of atrazine and its possible bond breaking positions.

FIGS. 33A-33D present atrazine degradation dynamics [adsorption/degradation] of unmodified (FIG. 33A) MK10, (FIG. 33B) modified MK10, (FIG. 33C) unmodified sand and (FIG. 33D) modified sand.

FIGS. 34A-34B present First-order kinetics (FIG. 34A) and second-order kinetics (FIG. 34B), of atrazine degradation by modified MK10 and sand by PEI-Cu-NPs.

FIG. 35 presents schematic representation of possible mechanism.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

In one embodiment, this invention is directed to a degradation composite comprising reduced copper(II)-based nanoparticles coordinated to a polymer forming a complex (Cu-NPs), wherein said polymer is an amino based polymer. In another embodiment, the amino based polymer is polyethylenimine and said composite comprises reduced Cu(II)-polyethylenimine complex.

In one embodiment, the term “Cu-NPs” in this invention refers to reduced Cu(II)-based nanoparticles coordinated to a polymer forming a complex. In another embodiment the polymer is an amino based polymer forming a complex with the reduced Cu(II) based nanoparticles. PEI-Cu-NPs is a specific example where the polymer is polyethylenimine.

In some embodiments, the degradation composite of this invention comprises Cu-NPs complex of this invention incorporated into a solid support. In one embodiment, the degradation composite of this invention comprises Cu-NPs complex of this invention incorporated into a silica based material. In another embodiment, the silica based material comprises clay, sand, zeolite or combination thereof. In another embodiment, the Cu-NPs which are incorporated into the silica based materials enable easy reuse of the Cu-NPs.

In one embodiment, the degradation composite comprising the Cu-NPs incorporated into the silica based materials can be separated/filtered from the pollutant solution/mixture because of the larger size of the pores of the silica-based materials compared to the Cu-NPs and thus can be reused.

A silica based material refers to material with a Si—O bond.

This invention provides, in some embodiments, a degradation composite, kit, device, and methods for decontaminating, and/or detoxifying, fluids by oxidizing/hydrolyzing, and/or degrading pollutants/contaminants. In one embodiment, such degradation composite, kit, device and methods will find application in the treatment of toxic waste products. In another embodiment, such degradation composite, kit, device and methods will find application in the treatment of effluents resulting from industrial production of various chemical compounds, or pharmaceuticals. In another embodiment, such degradation composite, kit, device and methods will find application in the treatment of water supplies (rivers, streams, sea water, lake water, groundwater, etc.) contaminated by chemical compounds or toxic materials. In another embodiment, such degradation composite, kit, device and methods will find application in the treatment of toxic waste products due to occurrence of a natural disaster. In another embodiment, such degradation composite, kit, device and methods will find application in the treatment of petroleum spills. In another embodiment, such degradation composite, kit, device and methods will find application in the treatment of process water in the petroleum industry. In another embodiment, such degradation composite, kit, device and methods applications in the treatment of environmental pollutants. In another embodiment, such degradation composite, kit, device and methods will find application in the decontamination of water. In another embodiment, such degradation composite, kit, device and methods will find application in the decontamination of chemical reactions. In another embodiment, such degradation composite, kit, device and methods will find application in the decontamination of organic solvents. In another embodiment, such degradation composite, kit, device and methods will find application in the decontamination of air. In another embodiment, such degradation composite, kit, device and methods will find application in the decontamination of gases. In another embodiment, such degradation composite, kit, device and methods will find application in the decontamination of weapons of mass destruction (W.M.D), or in another embodiment, biological, virus, and/or chemical (including gas and liquid) weapons. In another embodiment, such degradation composite, kit, device and methods will find application in the decontamination of oil tankers, transport containers, plastic containers or bottles. In another embodiment, such degradation composite, kit, device and methods will find application in the decontamination of soil. In another embodiment, such degradation composite, kit, device and methods will find application in the decontamination of filters, for example, air purification and air-conditioning filters.

This invention provides a degradation composite used in advanced oxidation processes (AOP) wherein a polymer is used to stabilize the copper nanoparticles. The Cu-NPs of this invention are highly efficient in AOP for water decontamination from organic pollutants.

In one embodiment, the degradation composite, kit, device and methods comprise and make use of a reduced Cu(II)-based nanoparticles coordinated to a polymer. In another embodiment, the polymer stabilizes the reduced Cu(II)-based nanoparticles. In another embodiment, the polymer is branched. In another embodiment, the polymer is dendritic. In another embodiment, the polymer is linear. In another embodiment, the polymer is an amino based polymer. In another embodiment, the polymer is polyethylenimine. In another embodiment, the polymer is chitosan. In another embodiment, the polymer is poly(vinyl alcohol). In another embodiment, the polymer is polyvinylpyrrolidone (PVP). In another embodiment, the polymer is tetraalkylammonium halides. In another embodiment, the polymer is guar gum. In another embodiment, the polymer is sodium carboxymethyl cellulose. In another embodiment, the polymer is cellulose. In another embodiment, the polymer is nylon. In another embodiment, the polymer is xanthan gum. In another embodiment, the polymer is polyacrylic acid. In another embodiment, the polymer is polymethylmethacrylate (PMMA). In another embodiment, the polymer is polyethylene glycol (PEG). In another embodiment, the polymer is polymaleic acid. In another embodiment, the polymer is a copolymer. In another embodiment, the copolymer comprises polyethylenimine, chitosan, polyvinyl alcohol, polyvinylpyroolidone, guar gum, carboxymethyl cellulose, cellulose, nylon, xanthan gum, polyacrylic acid, polymethylmethacrylate, polyethylene glycol, polymaleic acid, polystyrene or any combination thereof.

In one embodiment, this invention is directed to a degradation composite comprising reduced copper(II)-based nanoparticles coordinated to a polymer forming a complex (Cu-NPs), wherein said complex is incorporated into a silica based material.

In one embodiment, this invention is directed to a degradation composite comprising reduced copper(II)-based nanoparticles coordinated to an amino based polymer, forming a complex (Cu-NPs), wherein said complex is incorporated with a silica based material. In another embodiment, the amino based polymer is polyethylenimine. In another embodiment, the silica based material is sand, clay, zeolite or combination thereof.

In one embodiment, this invention is directed to a degradation composite, kit, device and methods comprising and make use of a silica based material. In another embodiment, the silica based material is sand, clay, zeolite or combination thereof. In another embodiment, the silica based material is sand. In another embodiment, the silica based material is clay. In another embodiment, the silica based material is SiO₂. In another embodiment, the silica based material is zeolite. In another embodiment, the silica based material is montmorillonite K10 (MK10). In another embodiment, the silica based material is ZSM-5. In another embodiment, the silica based material is H-ZSM-5.

In one embodiment, the degradation composite comprises reduced Cu(II)-nanoparticles coordinated to a polymer forming a complex (Cu-NPs) and the complex is incorporated into a silica based material. The term “incorporated” refers to impregnated, adsorbed or immobilized. Thus, in one embodiment, the Cu-NPs complex is impregnated by the silica based material. In another embodiment, the Cu-NPs complex is immobilized on the silica based material. In another embodiment, the Cu-NPs complex is adsorbed on the silica based material.

In one embodiment, this invention provides a method of degrading organic pollutants wherein said method comprises contacting a pollutant and copper based nanoparticles, in the presence of an oxidant, wherein said copper based nanoparticles comprise reduced Cu(II)-polymer complex.

In one embodiment, this invention is directed to a method of degrading organic pollutants wherein said method comprises contacting a pollutant and a degradation composite comprising reduced copper(II)-based nanoparticle coordinated to a polymer (Cu-NPs), in the presence or absence of an oxidant. In another embodiment, the polymer is an amino based polymer. In another embodiment, the polymer is polyethylenimine and said composite comprises reduced Cu(II)-polyethylenimine complex. In another embodiment, the composite further comprises a silica based material and said Cu-NPs are incorporated into said silica based material. In another embodiment, the silica based material comprises clay, sand, zeolite or combination thereof.

In one embodiment, this invention provides a method of degrading organic pollutants wherein said method comprises contacting a pollutant and a degradation composite of this invention, in the presence of an oxidant, wherein said degradation composite comprises reduced Cu(II)-polyethylenimine complex.

In one embodiment, this invention provides a method of degrading organic pollutants wherein said method comprises contacting a pollutant and a degradation composite of this invention, in the presence or absence of an oxidant, wherein said degradation composite comprises reduced Cu(II)-polyethylenimine complex which is incorporated into a silica based material.

In one embodiment, this invention is directed to a degradation kit comprising:

a. an oxidizing agent; and

b. a degradation composite comprising reduced copper(II)-based nanoparticles wherein said reduced copper(II)-based nanoparticles are coordinated to a polymer forming a complex (Cu-NPs). In another embodiment, the polymer is amino based polymer. In another embodiment, the polymer is polyethylenimine and said composite comprises reduced Cu(II)-polyethylenimine complex. In another embodiment, the composite further comprises a silica based material and said Cu-NPs are incorporated into said silica based material. In another embodiment, the silica based material comprises clay, sand, zeolite or combination thereof.

In one embodiment, this invention is directed to a degradation kit comprising a degradation composite comprising reduced copper(II)-based nanoparticles wherein said reduced copper(II)-based nanoparticles are coordinated to a polymer forming a complex (Cu-NPs). In another embodiment, the polymer is amino based polymer. In another embodiment, the polymer is polyethylenimine and said composite comprises reduced Cu(II)-polyethylenimine complex. In another embodiment, the composite further comprises a silica based material and said Cu-NPs are incorporated into said silica based material. In another embodiment, the silica based material comprises clay, sand, zeolite or combination thereof. In another embodiment, the silica based material is acidic. In another embodiment, the silica based material is ZSM-5 or H-ZSM-5. In one embodiment, the Cu-NPs of this invention and for use in this invention are catalytic nanoparticles, which increase, in some embodiments, the rate of pollutant degradation by reducing the energy barrier for the reaction, by various mechanistic pathways. Non-limiting examples of mechanistic pathways include the utilization of the redox activity of the Cu ions found in the Cu-NPs composite and adsorption of substrates on the Cu-NPs surfaces. In another embodiment, catalytic nanoparticles maybe recycled.

In one embodiment, silica based materials ZSM-5 or H-ZSM-5 of this invention are catalysts, which increase, in some embodiments, the rate of pollutant degradation by reducing the energy barrier for the reaction, by various mechanistic pathways. Non-limiting examples of mechanistic pathways include the participation of the silica based materials ZSM-5 or H-ZSM-5 in acid catalytic hydrolysis of the substrates of the reaction and adsorption of substrates on the porous silica materials.

In one embodiment, the method, device and kit of this invention make use of copper based nanoparticles. In one embodiment, the method, device and kit of this invention make use of copper-based nanoparticles (Cu-NPs) wherein said copper based nanoparticles comprise reduced Cu(II)-polymer complex. In one embodiment, this invention provides copper based nanoparticles (Cu-NPs) which are prepared by mixing an aqueous solution of polyethylenimine with an aqueous solution of Cu²⁺ salt forming a Cu-polyethylenimine complex; followed by addition of a reducing agent, thereby reducing the Cu²⁺ and copper based nanoparticles (Cu-NPs) are formed.

The copper based nanoparticles (Cu-NPs) of this invention refer to copper-polymer nanoparticles. In another embodiment, the polymer is an amino based polymer. In another embodiment, the polymer is polyethylenimine. In another embodiment, the copper-polyethylenimine nanoparticles include reduced copper. In another embodiment, the Cu-NPs of this invention include Cu(I), Cu⁰, Cu(II), Cu₂O, CuO, dimeric Cu species or combination thereof. Non limiting examples of a dimeric Cu species include Cu²⁺—O²⁻—Cu²⁺, Cu²⁺—O²⁻—Cu²⁺, and Cu⁺ . . . Cu²⁺—O. In another embodiment, the Cu-NPs of this invention include Cu(I), Cu⁰ or combination thereof. In another embodiment, the Cu-NPs of this invention do not include Cu(II). In another embodiment, the Cu-NPs of this invention do not include CuO. In another embodiment, the Cu-NPs of this invention include between 50%-100% by weight elementary Cu⁰. In another embodiment, the Cu-NPs of this invention include between 70%-100% by weight elementary Cu⁰. In another embodiment, the Cu-NPs of this invention include between 90%-100% by weight elementary Cu⁰. In another embodiment, the Cu-NPs of this invention include less than 15% Cu(II) by weight. In another embodiment, the Cu-NPs of this invention include less than 15% CuO by weight. In another embodiment, the Cu-NPs comprise Cu₂O, elementary copper (Cu⁰), less than 15% by weight of CuO or combination thereof. In another embodiment, the Cu-NPs comprise 100% elementary copper (Cu⁰). In one embodiment, the method device and kit of this invention make use and/or comprise copper based nanoparticles (Cu-NPs) wherein said copper based nanoparticles comprise reduced Cu(II)-polymer complex.

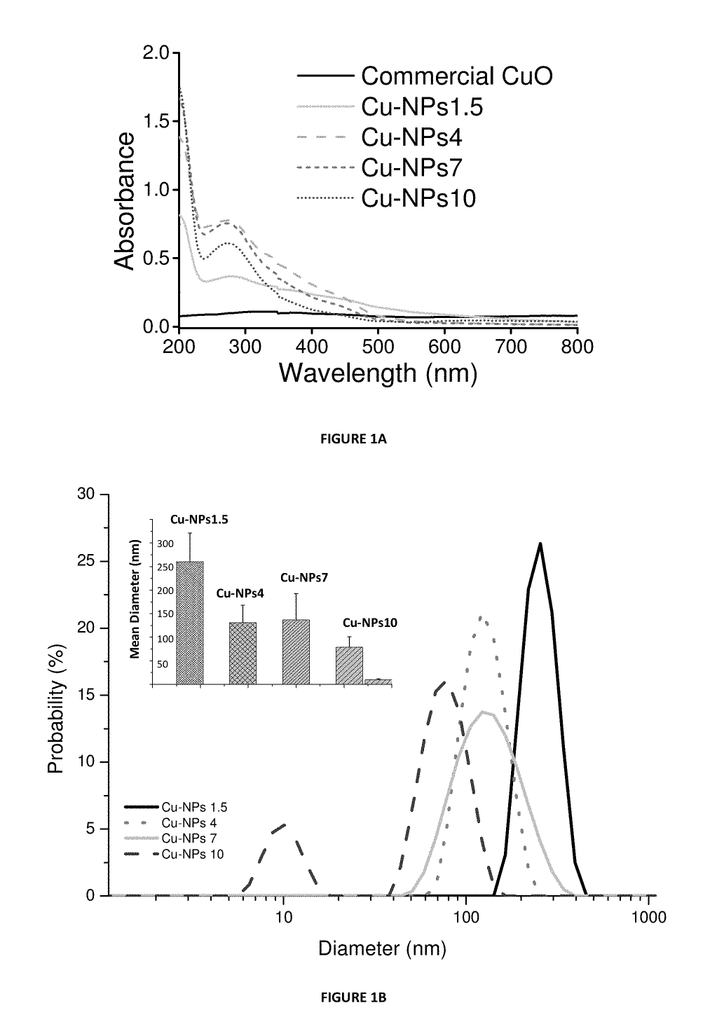

In one embodiment, the method, device and kit of this invention make use of a polymer. In another embodiment, the polymer is an amino based polymer. In another embodiment, the polymer is polyethylenimine (PEI). In another embodiment, as the concentration of polyethylenimine (PEI) increases, the mean average diameter of Cu-NPs decreases (FIG. 1B). In another embodiment, the mean average diameter of the Cu-NPs of this invention is between 2 nm and 300 nm. In another embodiment, the mean average diameter of the Cu-NPs of this invention is between 100 nm and 200 nm. In another embodiment, the mean average diameter of the Cu-NPs of this invention is between 75 nm and 250 nm. In another embodiment, the mean average diameters are 260±60 nm, 130±37 nm 136±56 and 78±21 nm for Cu-NPs1.5, Cu-NPs4, Cu-NPs7 and Cu-NPs10 (Example 1 and FIG. 1B; 1.5; 4; 7 and 10 refer to the amount of PEI added).

In one embodiment, the nanoparticles vary in terms of size, or in another embodiment, shape, or in another embodiment, composition, or any combination thereof, within kit, device and/or for use according to the methods of this invention. Such differences in the respective nanoparticles used in a particular kit/device or according to the methods of this invention may be confirmed via electron microscopy, or in another embodiment, by scanning electron microscopy (SEM), or in another embodiment, by tunneling electron microscopy (TEM), or in another embodiment, by optical microscopy, or in another embodiment, by atomic absorption spectroscopy (AAS), or in another embodiment, by X-ray powder diffraction (XRD), or in another embodiment, by X-ray photoelectron spectroscopy (XPS), or in another embodiment, by atomic force microscopy (AFM), or in another embodiment, by ICP (inductively coupled plasma), or in another embodiment, by TGA (thermal gravimetric analysis), or in another embodiment, by DLS (dynamic light scattering)

In one embodiment, the method, device and kit of this invention make use and/or comprise copper based nanoparticles (Cu-NPs). In another embodiment, the Cu-NPs of this invention comprise between 10% and 90% of polyethylenimine (PEI) by weight. In another embodiment, the Cu-NPs of this invention comprise between 20% and 50% of polyethylenimine (PEI) by weight. In another embodiment, the Cu-NPs of this invention comprise between 30% and 60% of polyethylenimine (PEI) by weight. In another embodiment, the Cu-NPs of this invention comprise between 30% and 70% of polyethylenimine (PEI) by weight. In another embodiment, the Cu-NPs of this invention comprise between 50% and 90% of polyethylenimine (PEI) by weight. In another embodiment, lower concentrations of PEI (lower than 10% by weight) do not stabilize the Cu-NPs, leading to aggregation and sedimentation of copper precipitants.

In another embodiment, the Cu-NPs of this invention comprise PEI, wherein the PEI is in the size range of between 0.5 kD and 750 kD.

In another embodiment, the Cu-NPs of this invention comprise PEI wherein the PEI is in the size range of between 10 kD and 150 kD.

In one embodiment the process for the preparation of the copper based nanoparticles includes mixing aqueous solution of Cu(II) salt with polyethylenimine forming a Cu(II)-PEI complex. In another embodiment, the Cu(II) salt is Cu(NO₃)₂, CuSO₄, CuCl₂, CuCO₃, Cu(CH₃COO)₂ or combination thereof. In another embodiment, the Cu(II) salt is Cu(NO₃)₂. In another embodiment, the Cu(II) salt CuSO₄. In another embodiment, the Cu(II) salt CuCl₂. In another embodiment, the Cu(II) salt CuCO₃. In another embodiment, the Cu(II) salt Cu(CH₃COO)₂. In another embodiment, the concentration of the Cu(II) salt in said solution is between 1-100 mM. In another embodiment, the concentration of the Cu(II) salt in said solution is between 10-100 mM. In another embodiment, the concentration of the Cu(II) salt in said solution is between 10-50 mM. In another embodiment, the concentration of the Cu(II) salt in said solution is between 1-50 mM. In another embodiment, the concentration of the Cu(II) salt in said solution is between 20-60 mM. In another embodiment, the concentration of the Cu(II) salt in said solution is between 30-100 mM. In another embodiment, the concentration of the Cu(II) salt in said solution is between 30-60 mM. In another embodiment, the concentration of the Cu(II) in the solution is about 50 mM.

In one embodiment the process for the preparation of the copper based nanoparticles includes mixing aqueous solution of Cu(II) salt with polyethylenimine (PEI) forming a Cu(II)-PEI complex, followed by reduction of the Cu(II) of the Cu(II)-PEI complex. In another embodiment, the molar ratio between the Cu(II) ions and polyethylenimine (PEI) is between 10 and 270. In another embodiment, the molar ratio between the Cu(II) ions and polyethylenimine (PEI) is between 10 and 50. In another embodiment, the molar ratio between the Cu(II) ions and polyethylenimine (PEI) is between 50 and 100. In another embodiment, the molar ratio between the Cu(II) ions and polyethylenimine (PEI) is between 75 and 150. In another embodiment, the molar ratio between the Cu(II) ions and polyethylenimine (PEI) is between 100 and 270. In another embodiment, the process for the preparation of the copper based nanoparticles is as described in Example 1.

In one embodiment, the process for the preparation of the copper based nanoparticles includes reducing a Cu(II) salt. In one embodiment, the process for the preparation of the copper based nanoparticles includes reducing a Cu(II)-PEI complex. In another embodiment, the Cu(II)-PEI complex is reduced by a reducing agent, or electrochemically. Non limiting examples of a reducing agent include hydrazine, ascorbic acid, hypophosphite, formic acid, sodium borohydride (NaBH₄) or combinations thereof. In another embodiment, the reducing agent is NaBH₄.

In one embodiment, this invention is directed to a method, device and kit for (i) degrading organic pollutants; (ii) oxidizing/hydrolyzing organic pollutants comprising contacting a pollutant and copper based nanoparticles (Cu-NPs) of this invention, in the presence of an oxidant for the oxidation, or its absence for the hydrolysis. In another embodiment, the method comprises mixing the Cu-NPs of this invention with the pollutant followed by the addition of the oxidant and thereby degrading and/or oxidizing the pollutant, for the oxidation process. In another embodiment, the method comprises mixing the Cu-NPs of this invention with the pollutant and thereby degrading and/or hydrolyzing the pollutant, for the hydrolysis process. In another embodiment, the method comprises contacting the oxidant with the pollutant followed by addition of the Cu-NPs of this invention thereby degrading and/or oxidizing the pollutant. In another embodiment, the Cu-NPs are in aqueous solution/suspension/emulsion.

In another embodiment, the contacting step between the pollutant and the Cu-NPs and oxidant is performed in aqueous solution. In another embodiment, the contacting step is in the soil. In another embodiment, the contacting step between the Cu-NPs and the oxidant is in aqueous solution and the solution is being applied on solid surfaces, soil, gases which possess pollutants.

In one embodiment, the method, device and kit of this invention make use of Cu-NPs of this invention which are suspended/mixed in aqueous solution. In another embodiment, the aqueous solution includes a salt. In another embodiment, the salt is an alkali salt or an alkaline salt. In another embodiment, the salt is NaHCO₃. In another embodiment, the salt is NaCl. In another embodiment, the concentration of the salt is between 1 mM and 2M. In another embodiment, the concentration of the salt is between 1 mM and 1M. In another embodiment, the concentration of the salt is between 10 mM and 1M. In another embodiment, the concentration of the salt is between 50 mM and 1M. In another embodiment, the concentration of the salt is between 0.5 M and 2M.

In one embodiment, the method, device and kit of this invention make use of Cu-NPs of this invention which are suspended/mixed in aqueous solution. In another embodiment, the pH of the aqueous solution is between 4 and 10. In another embodiment, the pH is between 4 and 6. In another embodiment, the pH is between 5 and 7. In another embodiment, the pH of the aqueous solution is between 4 and 8.

In one embodiment, the method, device and kit of this invention make use of Cu-NPs of this invention which are suspended/mixed in aqueous solution. In another embodiment, the concentration of the copper based nanoparticles (Cu-NPs) of this invention in the solution is equivalent to at least 0.15 mM of Cu. In another embodiment, the concentration of the copper based nanoparticles (Cu-NPs) of this invention in the solution is at least equivalent to 0.25 mM of Cu. In another embodiment, the concentration of the Cu-NPs of this invention in the solution is equivalent to concentrations between 0.2 and 10 mM of Cu. In another embodiment, the concentration of the Cu-NPs of this invention in the solution is equivalent to between 0.15 mM and 1 mM of Cu. In another embodiment, the concentration of the Cu-NPs of this invention in the solution is equivalent to between 0.15 mM and 0.25 mM of Cu. In another embodiment, the concentration of the Cu-NPs of this invention in the solution is equivalent to between 0.15 mM and 0.3 mM of Cu. In another embodiment, the concentration of the Cu-NPs of this invention in the solution is equivalent to between 0.2 mM and 0.5 mM of Cu. In another embodiment, the concentration of the Cu-NPs of this invention in the solution is between 1.25 mM and 5 mM of copper. In another embodiment, the copper is in its reduced form (i.e., Cu(0) or Cu(I).)

In one embodiment, the method, device and kit of this invention make use of an oxidant. An “oxidant” and “oxidizing agent” are referred herein as interchangeable terms. In another embodiment, the oxidant is a peroxide, a chromate, a chlorate, ozone, a perchlorate, permanganate, osmium tetraoxide, bromate, iodate, chlorite, hypochlorite, nitrate, nitrite, nitric acid, nitrogen dioxide, dinitrogen tetroxide, nitrous oxide, chlorine dioxide, 2,2,6,6-Tetramethylpiperidin-1-yl)oxyl (TEMPO), perborate, percarbonate, peroxymonosulphate, peroxydisulphate, an electron acceptor, or any combination thereof. In another embodiment, the oxidant is a peroxide. In another embodiment, the oxidant is a chromate. In another embodiment, the oxidant is a chlorate. In another embodiment, the oxidant is ozone. In another embodiment, the oxidant is a perchlorate. In another embodiment, the oxidant is permanganate. In another embodiment, the oxidant is osmium tetraoxide. In another embodiment, the oxidant is bromate. In another embodiment, the oxidant is iodate. In another embodiment the oxidant is chlorite. In another embodiment, the oxidant is hypochlorite. In another embodiment, the oxidant is nitrate. In another embodiment, the oxidant is nitrite. In another embodiment, the oxidant is nitric acid. In another embodiment, the oxidant is nitrogen dioxide. In another embodiment, the oxidant is dinitrogen tetroxide. In another embodiment, the oxidant is nitrous oxide. In another embodiment, the oxidant is chlorine dioxide. In another embodiment, the oxidant is 2,2,6,6-Tetramethylpiperidin-1-yl)oxyl (TEMPO). In another embodiment, the oxidant is perborate. In another embodiment, the oxidant is percarbonate. In another embodiment, the oxidant is peroxydisulphate. In another embodiment, the oxidant is a peroxymonosulphate. In another embodiment, the oxidant is an electron acceptor. In another embodiment, the oxidant is hydrogen peroxide (H₂O₂).

In another embodiment, the concentration of the oxidant in the solution is between 0.0005% and 10% w/v. In another embodiment, the concentration of the oxidant in the solution is between 0.001% to 10% w/v. In another embodiment, the concentration of the oxidant in the solution is between 0.005% and 10% w/v. In another embodiment, the concentration of the oxidant in the solution is between 0.001% and 1% w/v. In another embodiment, the concentration of the oxidant in the solution is between 0.01% and 10% w/v. In another embodiment, the concentration of the oxidant in the solution is between 0.01% and 2% w/v. In another embodiment, the concentration of the oxidant in the solution is between 0.05% and 1% w/v. In another embodiment, the concentration of the oxidant in the solution is between 0.01% and 1% w/v. In another embodiment, the concentration of the oxidant in the solution is between 0.05% and 1.5% w/v. In another embodiment, the concentration of the oxidant in the solution is between 0.075% and 1.5% w/v. In another embodiment, the concentration of the oxidant in the solution is between 0.075% and 2% w/v. In another embodiment, the concentration of the oxidant in the solution is between 0.05% and 2% w/v. In another embodiment, the concentration of the oxidant in the solution is between 1.5% and 5% w/v. In another embodiment, the concentration of the oxidant in the solution is between 2% and 6% w/v. In another embodiment, the maximum dissolution range is 5-250 mg/L for ozone, depending on temperature and pressure.

In another embodiment, the oxidant is comprised of combinations of two or more oxidants, and in some embodiments, it is a combination of the agents described hereinabove. The term “electron acceptor” refers, in one embodiment, to a substance that receives electrons in an oxidation-reduction process. Examples of electron acceptors include Fe (III), Mn (IV), oxygen, nitrate, sulfate, Lewis acids, 1,4-dinitrobenzene, or 1,1′-dimethyl-4,4′ bipyridinium. In one embodiment, the method of this invention is conducted under aerobic conditions and is for a period of time sufficient to oxidize said pollutant and thereby said pollutant degrades. In one embodiment, the method of this invention is conducted under anerobic conditions. In another embodiment, the pollutant degrades/oxidizes/hydrolyzes by 90-100%. In another embodiment, the pollutant degrades/oxidizes/hydrolyzes by 80-100%. In another embodiment, the pollutant degrades/oxidizes/hydrolyzes by 90% to 100% within 30 to 60 min. In another embodiment, the pollutant degrades/oxidizes/hydrolyzes by 80% to 100% within 30 to 60 min. In another embodiment, the pollutant degrades/oxidizes/hydrolyzes by 90% to 100% within 50 to 60 min. In another embodiment, the pollutant degrades/oxidizes/hydrolyzes by 90% to 100% within 10 to 60 min. In another embodiment, the pollutant degrades/oxidizes/hydrolyzes by 90% to 100% within 1 h to 8 h. In another embodiment, the pollutant degrades/oxidizes/hydrolyzes by 90% to 100% within 1 h to 24 h. In another embodiment, the pollutant degrades/oxidizes/hydrolyzes by 80% to 100% within 1 h to 24 h. In another embodiment, the pollutant degrades/oxidizes/hydrolyzes by 90% to 100% within 30 min to 2 h. In another embodiment, the pollutant degrades/oxidizes/hydrolyzes by 90% to 100% within 30 min to 3 h. In another embodiment, the pollutant degrades/oxidizes/hydrolyzes by 90% to 100% within 30 min to 4 h. In another embodiment, the pollutant degrades/oxidizes/hydrolyzes by 80% to 100% within 30 min to 4 h.

In another embodiment, the pollutant degrades/oxidizes/hydrolyzes to the regulated levels according to as defined by the relevant authorities. In another embodiment, the pollutant degrades/oxidizes/hydrolyzes to the regulated levels within 10 to 60 min. In another embodiment, the pollutant degrades/oxidizes/hydrolyzes to the regulated levels within 1 h to 8 h. In another embodiment, the pollutant degrades/oxidizes/hydrolyzes to the regulated levels within 1 h to 24 h. In another embodiment, the pollutant degrades/oxidizes/hydrolyzes to the regulated levels within 30 min to 2 h. In another embodiment, the pollutant degrades/oxidizes/hydrolyzes to the regulated levels within 30 min to 3 h. In another embodiment, the pollutant degrades/oxidizes/hydrolyzes to the regulated levels within 30 min to 4 h.

In another embodiment, the kits, device may be used at, or the methods of this invention may be conducted at room temperature (between 20-40° C.). In one embodiment, the methods of this invention may be conducted at a temperature of between about 20-30° C. In one embodiment, the methods of this invention may be conducted at a temperature of between about 30-35° C. In one embodiment, the methods of this invention may be conducted at a temperature of between about 35-40° C. In one embodiment, the methods of this invention may be conducted at a temperature of between about 40-45° C. In one embodiment, the methods of this invention may be conducted at a temperature of between about 45-50° C. In one embodiment, the methods of this invention maybe conducted at a temperature of between about 50-60° C. In one embodiment, the methods of this invention may be conducted at a temperature of between about 60-80° C. In one embodiment, the methods of this invention may be conducted at a temperature of between about 20-60° C. In one embodiment, the methods of this invention may be conducted at a temperature of between about 20-80° C. In one embodiment, the methods of this invention may be conducted at a temperature of between about 4-60° C. In one embodiment, the methods of this invention may be conducted at a temperature of between about 0-80° C. In one embodiment, the methods of this invention may be conducted at a temperature above 80° C.

In one embodiment, the method device and kit of this invention make use of an organic pollutant. In another embodiment, the organic pollutant includes a chemical contaminant, a biological contaminant, a wastewater, a hydrocarbon, an industrial effluent, a municipal or domestic effluent, an agrochemical, an herbicide, a pharmaceutical or any combination thereof. In another embodiment, the Cu-NPs show reactivity toward a wide range of common anthropogenic aquatic pollutants. In another embodiment, the Cu-NPs show activity and degradation of nonlimiting examples such as atrazine, bisphenol A, carbamazepine (CBZ), DBP, MTBE, phenol, naphthalene, rhodamine 6G and xylene.

In one embodiment, the invention is directed to a degradation kit comprising of:

a. an oxidizing agent; and

b. copper based nanoparticles wherein said copper based nanoparticles comprise reduced Cu(II)-polyethylenimine complex (Cu-NPs). In another embodiment, the kit is being used for degradation and/or oxidation of a pollutant.

In one embodiment, the invention is directed to a degradation kit comprising copper based nanoparticles wherein said copper based nanoparticles comprise reduced Cu(II)-polyethylenimine complex (Cu-NPs). In another embodiment, the kit is being used for degradation and/or hydrolysis of a pollutant.

In one embodiment, this invention is directed to a degradation kit comprising:

a. an oxidizing agent; and

b. a degradation composite comprising reduced copper(II) based nanoparticles whereinsaid reduced copper(II) based nanoparticles are coordinated to an amino based polymer forming a complex (Cu-NPs). In another embodiment, the polymer is polyethylenimine and said composite comprises reduced Cu(II)-polyethylenimine complex. In another embodiment, the composite further comprises a silica based material and said Cu-NPs are incorporated into said silica based material. In another embodiment, the silica based material comprises clay, sand, zeolite or combination thereof.

In one embodiment, this invention is directed to a degradation kit comprising a degradation composite comprising reduced copper(II) based nanoparticles wherein said reduced copper(II) based nanoparticles are coordinated to an amino based polymer forming a complex (Cu-NPs). In another embodiment, the polymer is polyethylenimine and said composite comprises reduced Cu(II)-polyethylenimine complex. In another embodiment, the composite further comprises a silica based material and said Cu-NPs are incorporated into said silica based material. In another embodiment, the silica based material comprises clay, sand, zeolite or combination thereof.

In one embodiment, the term “kit” refers to a packaged product, which comprises the oxidizing agent (if the kit is directed to oxidations) and nanoparticle, stored in individual containers, or a single container, at pre-determined ratios and concentration, for use in the degradation of a specified pollutant, for which the use of the kit has been optimized, as will be appreciated by one skilled in the art.

In one embodiment, the choice of oxidizing agent and/or nanoparticle composition and/or polymer and/or silica based material will depend upon the particular pollutant.

In one embodiment, the kit will contain instructions for a range of uses of the individual components, which may be present in the kit at various concentrations and/or ratios, in individually marked containers, whereby the end-user is provided optimized instructions for use in a particular application.

In one embodiment, the kits are comprised of agents whose composition and/or concentration are optimized for the types of pollutants for which the kits will be put to use.

In one embodiment, the kits comprise oxidizing agents and nanoparticles in individual containers, and the kit may be stored for prolonged periods of time at room temperature. In one embodiment, the kits of this invention may comprise oxidizing agents and nanoparticles in a single container, with the components segregated within the container, such that immediately prior to use, the individual components are mixed and ready for use. In one embodiment, such segregation may be accomplished via the use of membrane which may be ruptured or compromised by the application of force or a tool specific for such rupture. In one embodiment, such kits may be stored for prolonged periods of time at room temperature.

In one embodiment, the kits of this invention may comprise oxidizing agents, and nanoparticles in a single container, in a mixture, as a fluid. In one embodiment, such kits may be stored frozen for prolonged periods of time and upon thawing are ready-to-use.

In one embodiment, the kits comprise nanoparticles in a single container, with the components segregated within the container, such that immediately prior to use, the individual components are mixed and ready for use. In one embodiment, such segregation may be accomplished via the use of membrane which may be ruptured or compromised by the application of force or a tool specific for such rupture. In one embodiment, such kits may be stored for prolonged periods of time at room temperature.

In one embodiment, the kits of this invention may comprise nanoparticles in a single container, in a mixture, as a fluid. In one embodiment, such kits may be stored frozen for prolonged periods of time and upon thawing are ready-to-use.

In one embodiment, the kits may additionally comprise an indicator compound, which reflects partial or complete degradation of the contaminant.

In another embodiment, the Cu-NPs of this invention remain as a stable suspension (in water) for between 1 and 3 months. In another embodiment, the Cu-NPs of this invention remain as a stable suspension (in water) for more than one month.

In one embodiment, the metal nanoparticles are recovered, or in another embodiment, recycled, or in another embodiment, regenerated and/or further reused after degradation of the pollutant.

In one embodiment, such nanoparticle recovery, reuse, recycle or regeneration may be accomplished by settling, sieving, filtration via, e.g., membranes and/or packed beds, magneto-separation, complexation/sorption, extraction, optionally followed by washing of the nanoparticles after their recovery. In one embodiment, the recovery is via centrifugation. In one embodiment, the nanoparticles may be reused multiple times, following recovery from an aqueous solution and/or device and/or kit of this invention. In another embodiment, the nanoparticles may be regenerated. In another embodiment, the nanoparticles may be regenerated by applying a reducing agent/oxidizing agent to yield the desired oxidation state of the nanoparticles. In another embodiment, the nanoparticles may be regenerated from a colloidal form, by applying surfactants. In another embodiment, the nanoparticles may be regenerated by precipitation of them with a suitable anti solvent. In another embodiment, the nanoparticles may be regenerated by isolating the copper based product formed in the degradation/oxidation, method and/or kit and prepare the desired nanoparticle using the isolated copper based product.

In one embodiment, this invention provides a device comprising:
a. a first reaction chamber comprising Cu-NPs of this invention;
b. a first inlet for the introduction of a pollutant containing fluid into said first reaction chamber;
c. a second inlet for the introduction of an oxidizing agent to said first reaction chamber;
d. an outlet; and
e. a first channel, which conveys the degradation product from said first reaction chamber to said outlet;
   whereby the pollutant or a solution comprising the pollutant and the oxidizing agent are introduced to said first reaction chamber and contacted with said Cu-NPs of this invention under aerobic conditions; for a period of time sufficient to degrade said pollutant, and the degradation product is conveyed from said first reaction chamber to said outlet. In another embodiment, the device further comprises an additional inlet for the introduction of additional reduced Cu-NPs of this invention to the first reaction chamber. In another embodiment, the outlet includes a filter or a membrane which allows the fluid to be removed and to retain the nanoparticles in the reaction chamber.

In one embodiment, this invention provides a device comprising:
a. a first reaction chamber comprising Cu(II)-PEI complex;
b. a first inlet for the introduction of a pollutant containing fluid into said first reaction chamber;
c. a second inlet for the introduction of an oxidizing agent to said first reaction chamber;
d. a second reaction chamber comprising a reducing agent;
e. an outlet;
f. a first channel, which conveys the degradation product from said first reaction chamber to said outlet; and
g. a second channel, which conveys said reducing agent from said second reaction chamber to said first reaction chamber;
   whereby the reducing agent is conveyed from the second reaction chamber via the second channel to the first reaction chamber, thereby reducing the Cu(II)-PEI complex and forming reduced PEI-Cu-NPs nanoparticles; and whereby the pollutant or a solution comprising the pollutant and the oxidizing agent are introduced to said first reaction chamber and contacted with said PEI-Cu-NPs of this invention under aerobic conditions; for a period of time sufficient to degrade said pollutant, and the degradation product is conveyed from said first reaction chamber to said outlet.

In one embodiment, this invention provides a device comprising:
a. a first reaction chamber comprising Cu-NPs of this invention;
b. a first inlet for the introduction of a pollutant containing fluid into said first reaction chamber;
c. an outlet; and
d. a first channel, which conveys the degradation product from said first reaction chamber to said outlet;
   whereby the pollutant or a solution comprising the pollutant is introduced to said first reaction chamber and contacted with said Cu-NPs of this invention; for a period of time sufficient to degrade said pollutant, and the degradation product is conveyed from said first reaction chamber to said outlet. In another embodiment, the device further comprises an additional inlet for the introduction of additional Cu-NPs of this invention to the first reaction chamber. In another embodiment, the outlet includes a filter or a membrane which allows the fluid to be removed and to retain the nanoparticles in the reaction chamber.

In one embodiment, this invention provides a device comprising:
a. a first reaction chamber comprising PEI-Cu(II) complex;
b. a first inlet for the introduction of a pollutant containing fluid into said first reaction chamber;
c. a second reaction chamber comprising a reducing agent;
d. an outlet;
e. a first channel, which conveys the degradation product from said first reaction chamber to said outlet; and
f. a second channel, which conveys said reducing agent from said second reaction chamber to said first reaction chamber;
   whereby the reducing agent is conveyed from the second reaction chamber via the second channel to the first reaction chamber, thereby reducing the PEI-Cu(II) complex and forming reduced PEI-Cu-NPs nanoparticles; and whereby the pollutant or a solution comprising the pollutant is introduced to said first reaction chamber and contacted with said PEI-Cu-NPs of this invention; for a period of time sufficient to degrade said pollutant, and the degradation product is conveyed from said first reaction chamber to said outlet.

In another embodiment, the device further comprises an additional inlet for the introduction of a silica based material to the first reaction chamber. In another embodiment, the silica based material is added to the reduced PEI-Cu(II) nanoparticles in the first reaction chamber to obtain a reduced PEI-Cu(II)-silica composite.

In another embodiment, the device further comprises an additional inlet for the introduction of additional PEI-Cu(II) complex of this invention to the first reaction chamber. In another embodiment, the outlet includes a filter or a membrane which allows the fluid to be removed and to retain the nanoparticles in the reaction chamber.

In another embodiment, the solution comprising the pollutant is conveyed to said first reaction chamber followed by the conveyance of the oxidant and contacted with said Cu-NPs of this invention under aerobic conditions. In another embodiment, the solution oxidant is conveyed to said first reaction chamber followed by the conveyance of pollutant and contacted with said Cu-NPs of this invention under aerobic conditions.

In one embodiment, the devices of the invention may comprise multiple inlets for introduction of an oxidizing agent, reducing agent nanoparticles and/or air. In some embodiments, the device will comprise a series of channels for the conveyance of the respective pollutant, oxidizing agent, and other materials, to the reaction chamber. In some embodiments, such channels will be so constructed so as to promote contact between the introduced materials, should this be a desired application. In some embodiments, the device will comprise micro- or nano-fluidic pumps to facilitate conveyance and/or contacting of the materials for introduction into the reaction chamber.

In another embodiment the devices of this invention may comprise a stirrer in the device, for example, in the reaction chamber. In another embodiment, the device may be fitted to an apparatus which mechanically mixes the materials, for example, via sonication, in one embodiment, or via application of magnetic fields in multiple orientations, which in some embodiments, causes the movement and subsequent mixing of the magnetic particles. It will be understood by the skilled artisan that the devices of this invention are, in some embodiments, designed modularly to accommodate a variety of mixing machinery or implements and are to be considered as part of this invention.

In one embodiment the oxidizing agent is conveyed directly to the first reaction chamber, such that it does not come into contact with the contaminated fluid, prior to entry within the chamber, in the presence of the nanoparticles. In one embodiment, such conveyance is via the presence of multiple separate chambers or channels within the device, conveying individual materials to the chamber. In another embodiment, the chambers/channels are so constructed so as to allow for mixing of the components at a desired time and circumstance.

In one embodiment, the devices may further include a separated channel for conveying the pollutant to the reaction chamber.

In one embodiment, the devices may further include additional means to apply environmental controls, such as temperature, pressure and/or pH. In one embodiment, the device of the invention may include a magnetic field source and mixer to permit magnetically-controlled fluidizing. In another embodiment, the devices may include a mechanical stirrer, a heating, a light, a microwave, an ultraviolet and/or an ultrasonic source. In one embodiment, the device of the invention may include gas bubbling.

In one embodiment, the term “sufficient time” refers to a period of time for achieving the desired outcome.

In one embodiment, the term “contacting” refers to bubbling or mixing of the pollutants and the Cu-NPs in aqueous solution. In one embodiment, the chamber wherein the two′ are contacted may comprise a mixer, or agitating stir bar. In one embodiment, magnetic fields are applied in varying orientation, which in turn result in mixing of the magnetic nanoparticles within the fluid. In another embodiment, the term “contacting” refers to indirect mixing, wherein the mixing may be accomplished via conveyance through a series of channels, which result in mixing of the desired fluid. In one embodiment, the term “contacting” refers to direct mixing wherein the pollutant with an oxidizing agent and a nanoparticle, is mixed by stirring, stirring with a mechanical stirring, exposing or shaking of such combination. In another embodiment, the term “mixing” is to be understood as encompassing the optional application of a magnetic field, heat, microwaves, ultraviolet light and/or ultrasonic pulses, to accelerate the reaction. In another embodiment, the term “mixing” is to be understood as encompassing the improving of the yield of the process by the application of stirring, shaking and optionally application of a magnetic field, heat, light, microwaves, ultraviolet light and/or ultrasonic pulses.

In one embodiment, such contacting of the Cu-NPs of this invention and oxidizing agent may be conducted prior to contacting with the pollutant. In another embodiment, the oxidizing agent is contacted with the pollutant prior to contacting with the Cu-NPs of this invention. In another embodiment, the oxidizing agent, the Cu-NPs of this invention and the pollutant are simultaneously mixed.

In one embodiment, the term “about” refers to a deviance of between 0.0001-5% from the indicated number or range of numbers. In one embodiment, the term “about” refers to a deviance of between 1-10% from the indicated number or range of numbers. In one embodiment, the term “about” refers to a deviance of up to 25% from the indicated number or range of numbers.

The following examples are presented in order to more fully illustrate the preferred embodiments of the invention. They should in no way be construed, however, as limiting the broad scope of the invention.

### EXAMPLES

Chemicals.

All chemical reagents were used without any purification. Ultrapure water (18 MΩ cm⁻¹) was used for all experiments. Bisphenol A ((CH₃)₂C(C₆H₄OH)₂), carbamazepine (CBZ, C₁₅H₁₂N₂O), cupric nitrate trihydrate (CuN₂O₆.3H₂O, of Fluka), copper(II) oxide (CuO, nanopowder—particle size >50 nm), 2-6-dibromophenol (DBP; Br₂C₆H₃OH), dimethyl sulfoxide (DMSO; C₂H₆OS), phenol (C₆H₆O), polyethylenimine (PEI; H(NHCH₂CH₂)ₙNH₂, branched, M_{w}=25,000 Da), α-(4-Pyridyl N-oxide)-N-tert-butylnitrone (POBN; 99%; C₁₀H₁₄N₂O₂), tert-butyl-methyl-ether (MTBE; (CH₃)₃COCH₃), nitric acid (HNO₃, >69%), naphthalene (C₁₀H₈), rhodamine 6G (C₂₈H₃₁N₂O₃Cl), hydrochloric acid (HCl), phosphoric acid (H₃PO₄), methanol, methylene chloride, potassium hydrogen phthalate (KHP, Sigma Ultra, minimum 99.95%), AQUANAL™-professional tube test COD (chemical oxygen demand, 0-150 mg L⁻¹) and montmorillonite K10 (surface area 220-270 m² g⁻¹)) (denoted here, throughout, as “MK10”) were obtained from Sigma-Aldrich (Rehovot, Israel); sulphuric acid (H₂SO₄), sodium carbonate (Na₂CO₃) and dipotassium hydrogen phosphate (K₂HPO₄) were purchased from Merck; hexane (C₆H₄), hydrogen peroxide (H₂O₂, 30%), sodium hydroxide (NaOH) and xylene (C₈H₁₀) were purchased from Biolab LTD (Jerusalem, Israel); sodium borohydride (NaBH₄) was purchased from Nile Chemicals (Mumbai, India), toluene (C₆H₆CH₃) was obtained from Frutarom LTD. (Haifa, Israel); technical atrazine (99%)—6-chloro-N2-ethyl-N4-isoprophyl-1,3,5,-triazine-2,4-diamine (C₈H₁₄ClN₅) was received from Agan Chemical Manufacturers LTD. (Ashdod, Israel); acetonitrile (CH₃CH) from J.T.Baker—(Beith Dekel LTD., Raanana, Israel), 5,5-Dimethyl-1-pyrroline N-oxide (DMPO; C₆H₁₁NO) of Enzo Life Sciences were purchased from Almog Diagnostic Medical Equipment (Shoham, Israel); Sand was obtained from Unimin corporation (CAS#14808-60-7), Le Sueur, Minn. 56058, USA.

### Example 1

### Preparation and Characterization of Copper Nanoparticles (Cu-NPs)

Methods:

A stock solution of 1.6 mM PEI in DI water was prepared. Then, different volumes (1.5, 4, 7, and 10 mL) of the PEI stock solution were mixed for 5 min with 10 or 5 mL of 250 mM Cu(NO₃)₂ solution and complementary aliquot of DI water for achieving total volume of 40 mL. During this stage the solution color was dark blue due to formation of PEI-Cu complexes. Subsequently, addition of 10 mL of 0.5 M NaBH₄ to the solution reduced the soluble copper cation to elemental copper and a mixture of copper (I and II) oxides, giving rise to a color change from blue to reddish-brown, followed by formation of copper nanoparticles (Cu-NPs1.5, Cu-NPs4, Cu-NPs7 and Cu-NPs10 respectively): Cu-NPs1.5 refer to Cu-NPs of this invention wherein 1.5 mL of PEI stock solution were added to Cu(II) solution; Cu-NPs4 refer to Cu-NPs of this invention wherein 4 mL of PEI stock solution were added to Cu(II) solution; Cu-NPs7 refer to Cu-NPs of this invention wherein 7 mL of PEI stock solution were added to Cu(II) solution; and Cu-NPs10 refer to Cu-NPs of this invention wherein 10 mL of PEI stock solution were added to Cu(II) solution. The formation of Cu-NPs of this invention was coupled with immediate change in suspension color at the end of the reaction, from reddish-brown to green. The 50 mL Cu-NP suspension was stirred (˜350 rpm) for 1 h and finally, dialyzed for 1 day (Cellu Sep: 3500 MWCO, Membrane Filtration Products, Inc, TX, USA) in a glass beaker filled with 950 mL DI water. 10 mL from the Cu-NP suspension solution that was entrapped within the dialysis membrane and 10 mL of the DI water outside the dialysis bag, were acidified (0.1% HNO₃) to quantify the concentrations of copper and boron with an inductive coupled plasma mass-spectrophotometer (ICP-MS; 7700 series, Agilent Technology).

CuO suspension was prepared by the addition of 4 g commercial CuO powder to 1 L DI water. The CuO suspension was sonicated for at least 10 min before every exertion.

Light absorption spectra (UV-Visible Spectrophotometer, Cary 100 Bio, Varian Inc.) of the different Cu-NPs and zeta potential (ZetaSizer, Malvern) were conducted with diluted Cu-NP suspension. Dynamic Light Scattering (DLS; Zetasizer Micro V, Malvern) measurements were carried out also with dilute Cu-NP suspension with temperature of 25° C., at an angle of 90°, a wavelength of 830 nm, and 10 measurements each. XRD patterns were obtained on a Ultima III (Rigaku, Japan) model powder diffractometer using Cu Kα radiation with 2θ degree scan (Bragg-Brentano mode), 40 kV and 40 mA. Before X-ray diffraction (XRD) measurement, the Cu-NP suspensions were dried under strict anoxic conditions in order to prevent a change in the oxidation state of the Cu-NP. Ten mL aliquots of the Cu-NP suspensions were placed separately in 50 mL Falcon centrifuge tubes covered with Kimwipes, and freeze-dried overnight (SP Scientific VirTis lyophilizer) at approximately −80° C. and 45 mBar. The dry material appeared as a fluffy blue-green solid, which then collapsed to give a viscous material of the same color. The samples were immediately transferred to a nitrogen atmosphere in a drybox (<1 ppm O₂, <10 ppm H₂O). XRD samples were prepared in the drybox in sealed airtight sample holders. Measurements were performed in a Bruker AXS spectrometer using a Cu tube (1.54184 Å) x-ray source and Lynxeye detector from 2θ=10° to 100°. The data thus obtained were compared with Tenorite (CuO, ICSD-FIZ database number 073-6023), Cuprite (Cu₂O, ICDD database number 005-0667) and elemental copper (Crystallography open database REV 30738 number 9012043). Scanning electron microscopy (SEM) images was performed with Zeiss Supra 55 VP FEG High resolution instrument and the functional group change was recorded using NICOLET 6700 FT-IR, Thermo Scientific Inc.). All transmittance spectra were measured with KBr as background. Composition of the adsorbent was analyzed using a SDT Q600 V8.3 Build 101 thermal analyzer (DSC-TGA Standard). Samples were heated from room temperature to 750° C. at the heating rate of 20° C. min⁻¹ in nitrogen atmosphere in an alumina pan.

Results:

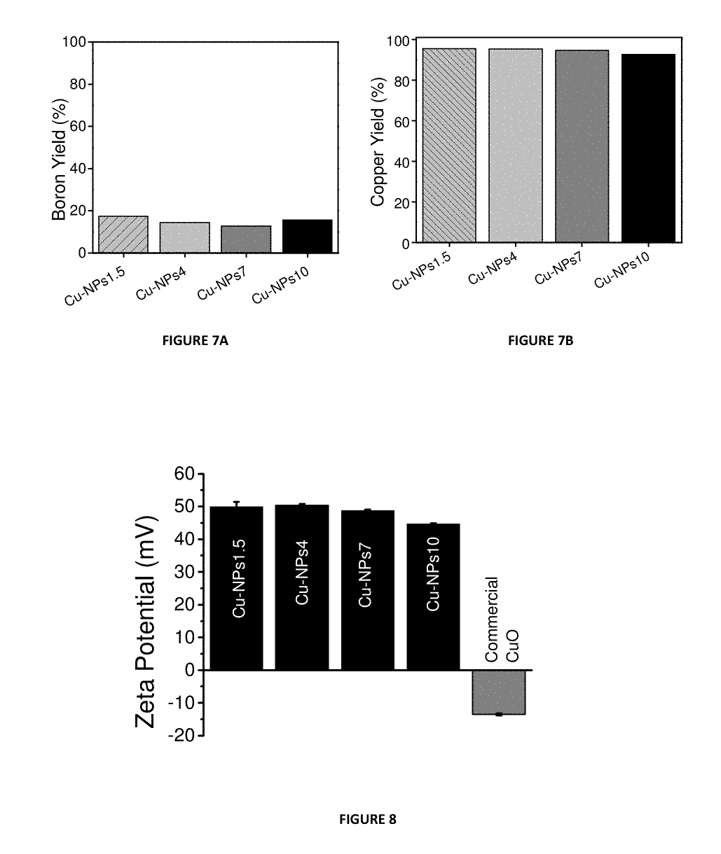

Initially, four types of Cu-NPs were synthesized with different concentrations of the stabilized agent polymer (PEI) while maintaining the same copper and NaBH₄ concentrations during particle synthesis Cu-NPs1.5, Cu-NPs4, Cu-NPs7, and CuNPs10 refer to 1.5, 4, 7, and 10 mL of 1.6 mM PEI solution supplemented in the 50 mL Cu-NP synthesized suspension (equivalent to final concentration of 48, 128, 224, and 320 μM of PEI in the Cu-NP suspension). Lower concentrations of PEI (<1.2 mL of 1.6 mM PEI solution) did not stabilize the Cu-NPs, leading to aggregation and sedimentation of copper precipitants. The synthesis procedure was initiated with mixing of the copper precursor with the PEI followed by chemical reduction by NaBH₄ which resulted in Cu-NP formation. Later on, a dialysis polishing stage of the Cu-NPs was conducted to remove non-reacted salt species. During this dialysis stage, the color of the particles changed from reddish brown to different hues of yellow-green, indicating partial or complete oxidation of the Cu-NPs. ICP-MS measurement showed that boron (from the precursor NaBH₄) diffused through the dialysis membrane and consequently was diluted in the Cu-NP suspension (yields of ˜15%), confirming the successful purification of the non-reacted salts (FIG. 7A). Copper remained in the Cu-NPs solution during the dialysis stage with more than 92% copper yield for all of the 4 Cu-NPs (FIG. 7B). Since by definition the four particles had different PEI content, the high and almost similar yields of copper remaining in the Cu-NP suspension after dialysis allowed comparisons between the particles, which were based on equal copper weight by using the same Cu-NP suspension volume. Based on the above yields, which range between 92 and 95%, all values of copper content of the synthesized nanoparticles should be considered as normalized to this range of yields. The pH of the Cu-NP suspension became more basic as the PEI concentration increased (8.13, 8.88, 9.31, and 9.62 for Cu-NPs1.5, Cu-NPs4, Cu-NPs7, and Cu-NPs10, respectively), implying that the basic amine functional groups of the PEI control the suspension pH. Despite the highly concentrated Cu-NP suspensions (50 mM as Cu ions), all of the Cu-NP suspensions were stable for months as deduced from the insignificant change of particle radius as measured by DLS (particle size change of <15 nm) and the lack of precipitation. This stability resulted from strong electric repulsion between the Cu-NPs, as indicated by a relatively high positive surface charge represented by zeta potential measurements (˜+40 mV for all the 4 Cu-NPs; FIG. 8). The Cu-NP positive charge is imparted by the protonation of the PEI amine functional groups. Since the pKa of PEI is between 9.5-11, it is likely that at pH values lower than the Cu-NP suspensions, the zeta potential should be similar or even become more positive, inferring stability of the Cu-NPs at most of the practical aquatic pH range.

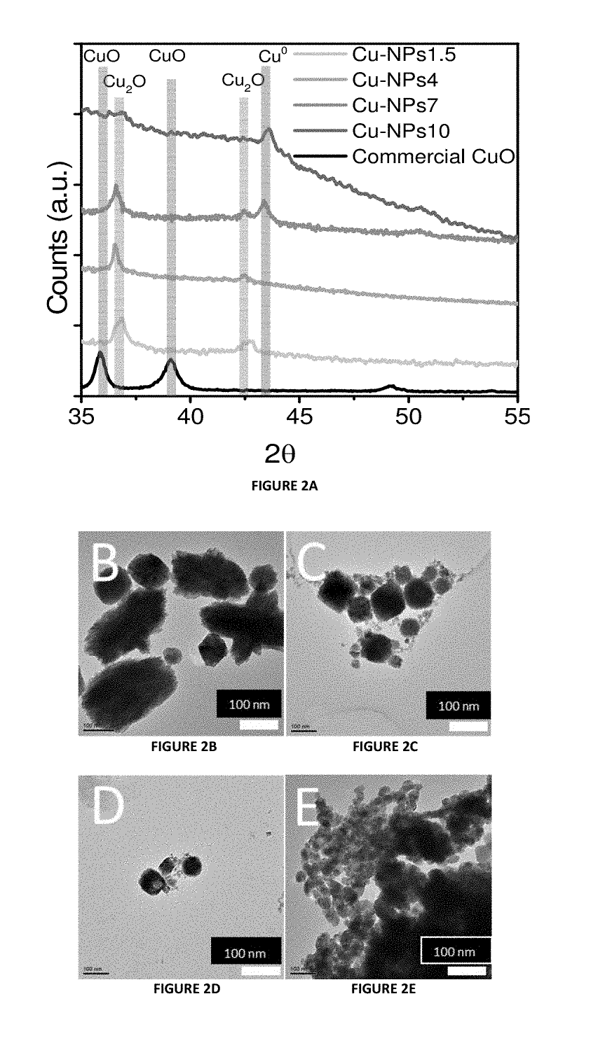

The Cu-NP properties were significantly affected by the PEI concentration during the synthesis. As the concentration of PEI increases, the mean average diameter of the Cu-NPs decrease (FIG. 1B), with sizes of 260±60, 130±37, and 136±56 nm for Cu-NPs1.5, Cu-NPs4, Cu-NPs-7, respectively. The particle size distribution of Cu-NPs10 was bi-modal with 78±21 and 10±2 nm. TEM images showed that the Cu-NPs are discrete, semi-spherical shape and their size decrease as the PEI portion increased (FIG. 2B-2D). Also, the PEI concentration maintained the hue of the Cu-NP suspension color as observed by bare eye and by UV-Vis absorption spectra (FIG. 1A). As the concentration of PEI decreases, less absorption is observed in the blue-green UV wavelength (˜400 nm), leading to more green-blue color in the Cu-NPs7 and 10 as compared to brown-yellow color of the Cu-NPs4 and 1.5. At the UV range, observed peak in ˜200 nm and ˜275 nm were ascribed to the Cu²⁺ absorption and PEI-Cu complex absorption in the absent of Cu-NPs (FIG. 9). Since absorption in the Vis range occurred only with the Cu-NPs and not with the Cu²⁺ or PEI-Cu complex alone, it can be deduced that the absorption in that range is associated with surface plasmon resonance of the NPs. or forms of copper different than Cu²⁺ found in the Cu-NPs. Indeed, XRD (FIG. 2A) measurements revealed that Cu-NPs1.5 and Cu-NPs-4 comprised only cuprite (Cu₂O), while Cu-NPs7 and Cu-NPs10 comprised also elemental copper; the higher the concentration of the PEI, the higher is the elemental copper content. In addition, there was no evidence to the appearance of tenorite (CuO), meaning that the PEI tends to prevent oxidation of the copper particles.

In contrast to the Cu-NPs, the commercial CuO suspension was transparent with no absorption in the UV-Vis range (FIG. 1A). DLS measurements were unstable and revealed particle sizes large than the device limits (>few μm). A TEM (FIG. 2E) image confirmed that the commercial CuO did not appear as discrete nano-size particles but rather as large aggregates (>few μm) and the measured zeta potential was mildly negative (−13.5 mV). The large CuO aggregates with the weak repulsive force led to their instability and rapid precipitation after a few hours when the solution was not agitated. In addition, XRD measurements (FIG. 2A) confirmed that these particles were comprised solely of tenorite (CuO).

Additional Cu-NP type was synthesized, Cu-NPs4-b, made similarly by the following procedure:

Stock solution of 1.6 mM PEI in ultra-pure water was prepared. 4 mL volume of the PEI stock solution were then mixed for 5 min with 5 mL of 250 mM Cu(NO₃)₂.3H₂O solution and ultra-pure water were added to achieve total volumes of 40 mL. Subsequently, addition of 10 mL of 0.5 M NaBH₄ was added into the solution to reduce the copper cation. The 50 mL Cu-NPs4-b suspension was stirred (˜350 rpm) for 1 h and then dialyzed for 1 day (Cellu Sep: 3500 MWCO, Membrane Filtration Products, Inc., TX, USA) in glass beakers filled with 950 mL DI water. The final Cu-NPs suspension was monodisperse with average particle size of 55.33 nm and zeta potential value of 33.4 mV.

### Example 2

### Degradation of Atrazine Using Cu-NPs of this Invention

Atrazine was dissolved in DI water by simultaneous heating and sonicating for a couple of hours, to obtain stock solution (20 mg L⁻¹). Glass vials (50 mL) were filled with 19 mL of atrazine stock solution, 100 μL of one of the four Cu-NP (Cu-NPs1.5, Cu-NPs4, Cu-NPs7, Cu-NPs10) or commercial CuO suspensions and 1 mL of 30% H₂O₂ solution (equivalent concentrations of 19 mg L⁻¹ atrazine, 0.25 mM Cu-NP/commercial CuO (15.75 mg L⁻¹ as Cu), and 1.5% H₂O₂). The mixed atrazine-Cu-NP/commercial CuO—H₂O₂ solutions were agitated at 350 rpm for 1 h under open atmospheric condition. At each predetermined time interval, 1 mL of the solution was filtered with 0.22 μm microfiltration disk (PVDF-0.22 μm, Millex-GV, Milipore) and 20 μL of the filtrated solution were injected to high pressure liquid chromatograph (HPLC; 1525 Binary HPLC Pump, Waters) with UV detector (2487 Dual λ Absorber Detector, Waters) measured at λ=222 nm. Eluent (75% acetonitrile: 25% DI) flow rate was 1 mL min⁻¹ with pressure of ˜1500 psi. The same above procedures were conducted for 20 mg L⁻¹ of atrazine that was dissolved in tap water instead of DI water. Also, in other experiments, the same procedure was followed but with different concentrations of H₂O₂ or Cu-NPs. In addition, the activity of each of the Cu-NP ingredients was examined by replacing the Cu-NPs with Cu(NO₃)₂ salt or PEI with final concentrations of 0.25 mM and 1.6 μM, respectively. At the end of each of the experiments, solution pH was measured. Each atrazine degradation experiment was repeated three times.

Results:

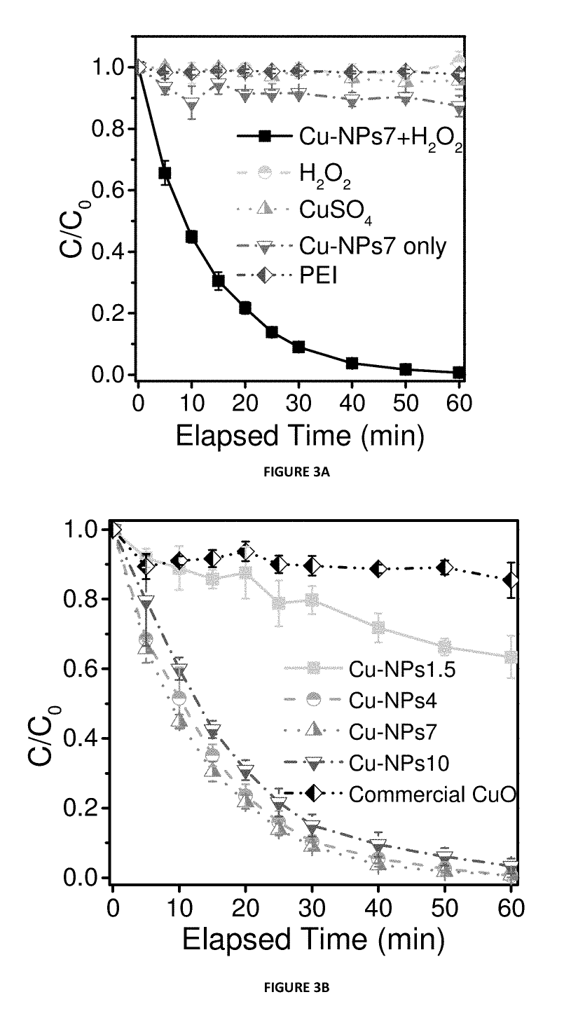

The activity of the synthesized Cu-NPs was demonstrated with atrazine as a model organic pollutant. Atrazine is a triazine class herbicide that is widely used worldwide, persistent, and tends to be mobilized toward the groundwater and to accumulate there. Thus, in many areas of the world, high concentrations of atrazine in groundwater pose a threat to drinking water quality. The atrazine degradation experiments were employed in a simple continuous stirred batch reactor configuration. When Cu²⁺ (as Cu salt), H₂O₂, or PEI were added to atrazine solution, there was no significant degradation during one hour of reaction (FIG. 3A). Also, addition of Cu-NPs alone did not lead to any significant change in atrazine concentration. However, combination of H₂O₂ with Cu-NPs resulted in very rapid atrazine dissipation with 90% reduction after 30 min and 99% reduction in less than 1 h. These observations reveal that the Cu-NPs exhibit unique properties which are different from their individual ingredients, and are responsible for the activity that efficiently activates H₂O₂. However, not all of the synthesized Cu-NPs showed the same activity. As can be seen in FIG. 3B, Cu-NPs1.5 had relatively weak activity with only 37% atrazine degradation after 1 h. Cu-NPs4, Cu-NPs7, and Cu-NPs10 degraded 90%, 91%, and 85% in 30 min and more than 99%, 99%, and 85% in 1 h, respectively. Commercial CuO (with the same molar ratio of copper to atrazine solution) only slightly reduced atrazine concentration (15%) after 1 h. This result demonstrates the superior activity of the synthesized Cu-NPs over the commercial CuO powder. The clear differences in activity can be related to the varied chemical composition of the particles and/or to their size which dictate the effective surface area in solution.

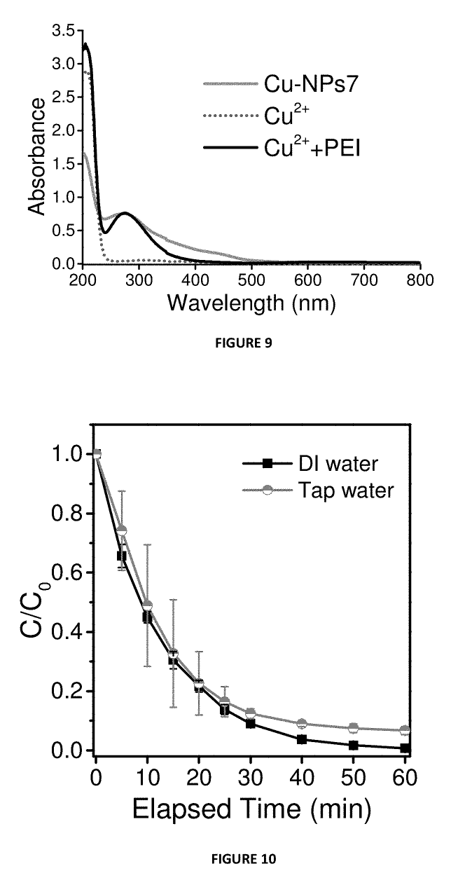

Because it was known that the solution chemistry may affect activity, such as by the presence of radical scavengers (e.g., HCO₃), the above atrazine degradation tests were initially conducted in DI water solution without any addition of chemicals. Due to the absent of buffer, in all of the experiments presented in FIG. 3B, the final solution pHs were acidic and ranged from 4.6±0.1 (for commercial CuO) to 5.37±0.03 (for Cu-NPs10) due to the acidic nature of the H₂O₂ solution. This narrow pH range indicates that the observed, different activity of the different particles is not likely to result from variations of pH but rather from variations in the Cu-NP characteristics. To demonstrate the reactivity in more realistic, near neutral pH and in more complex solution chemistry, degradation of atrazine was tested with tap water as the background solution. As can be seen in FIG. 10, the activity was only slightly weaker in atrazine dissolved in tap water (final solution pH was 7.64±0.47) as compared to DI water.

Different Concentrations of H₂O₂ and Different Concentrations of Cu-NPs7.

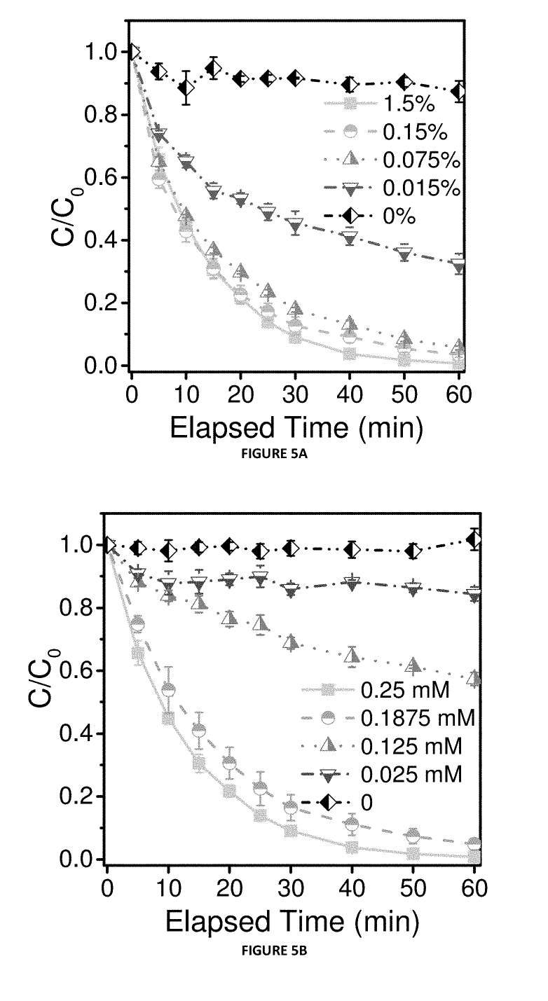

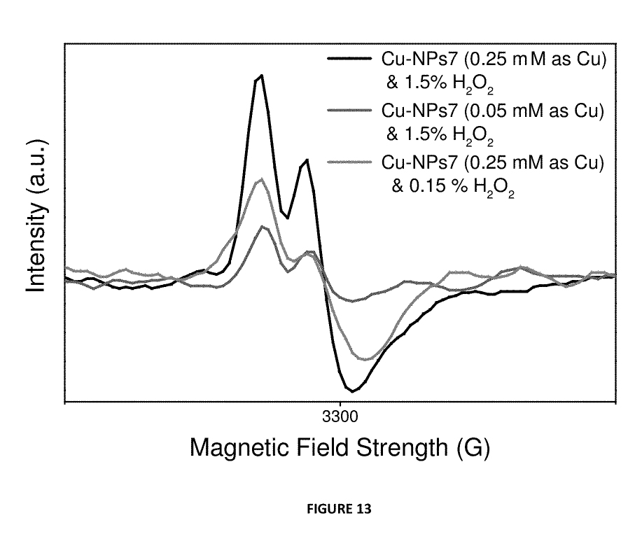

Atrazine degradation experiments were conducted with different concentrations of H₂O₂ (FIG. 5A) and different concentrations of Cu-NPs7 (FIG. 5B). Dilution by 10 and 20 times of the H₂O₂ concentration led to minor reduction in the reactivity (96.4% and 94.3% atrazine degradation after 1 h) compared to the initial concentration of 1.5% H₂O₂ (>99% atrazine degradation after 1 h). At 100 times dilution rate, significant reduction in the activity was observed, with, 67.5% of the atrazine attenuated after 1 h. With regard to the Cu-NP7 concentration, dilution of two times led to much weaker activity with only 42.6% atrazine degradation, while dilution of ten times essentially suppressed the activity, with atrazine degradation of only 15.6% after 1 h. Also, dilution of ten times of H₂O₂ concentration led to 1.72 times weaker ESR-POBN signals, while dilution of five time of the Cu-NP concentration led to 4.5 times weaker signal (FIG. 13). Thus, it can be inferred that in the atrazine degradation experiments depicted in FIG. 3A and FIG. 3B, the H₂O₂ was in excess with regard to the Cu-NPs, and that the limiting factor dictating the rate of hydroxyl radical formation and hence, the degradation rate, is the Cu-NP concentration.

Different Concentrations of H₂O₂ and Different Concentrations of Cu-NPs4.

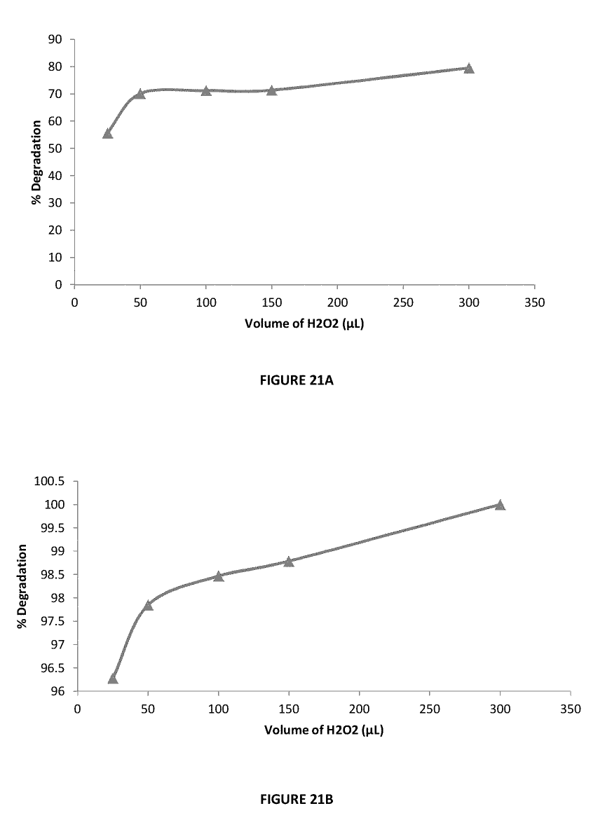

Atrazine degradation experiments were conducted with different concentrations of H₂O₂ using Cu-NPs4. The experiment was repeated using different volumes of 30% H₂O₂ using Cu-NP4. Specifically, instead of 1 mL of 30% H₂O₂ as described above, 25, 50, 100, 150 and 300 microliters (μL) were reacted with Cu-NP4 [5 mL. After 1 hour, degradation amounts (i.e., amounts of atrazine degraded) were, respectively, 55.7%, 70.1%, 71.2%, 71.4% and 79.5%. (FIG. 21A) and complete degradation after 15 h with the 300 μL H₂O₂ (FIG. 21B) respectively.

### Example 3

### Cu-NP Activity

Methods:

Electron spin resonance (ESR) was employed to qualitatively assess the intensity, the species, and the dynamics of the free radicals that were formed during the reaction. 19 mL DI water with 1 mL 30% H₂O₂ and 100 μL Cu-NP/CuO suspensions were mixed. At each time interval 180 μL of the solution was ejected and supplemented to an Eppendorf tube containing 20 μL POBN. The Eppendorf was then mixed with vortex for a few seconds, placed in the ESR device, and the signal of the nitroxyl radical of POBN was measured. EPR spectra were recorded on a Bruker ELEXSYS 500 X-band spectrometer equipped with a Bruker ER4102ST resonator in a Wilmad flat cell for aqueous solutions (WG-808-Q) at room temperature. Due to the inevitable attenuation of the observed ESR signal, every measurement was conducted exactly one minute after the addition of the solution to the POBN Eppendorf. In addition, the same procedure was repeated when the Cu-NPs7 were replaced with PEI or Cu²⁺ alone.

To examine the longevity of the activity, the above Cu-NPs7+H₂O₂ solution was stirred for one week. Each day, it was mixed with POBN and measured using the same procedure described above. In order to examine the possibility of Cu-NP poisoning, 1 mL of fresh H₂O₂ was added to the exhausted Cu-NPs7+H₂O₂ solution after one week, and the radical signal was measured to obtain the extent of radical signal recovery.

While POBN indicated the intensity of the total radical species, DMPO (5,5-dimethyl-1-pyrroline N-oxide) was utilized to identify the radical species that are formed during the reaction. The solution of Cu-NPs+H₂O₂ was prepared and after 30 min from the start of the reaction, the ESR spectrum was measured using the same procedure described above with DMPO (0.1 M) instead of POBN. The measurement was followed with the addition of 10% DMSO (as hydroxyl radical scavengers) to the DMPO sample, giving a weak spectrum with six lines typical of CH₃ as a results of reaction of DMSO with hydroxyl groups.

Results:

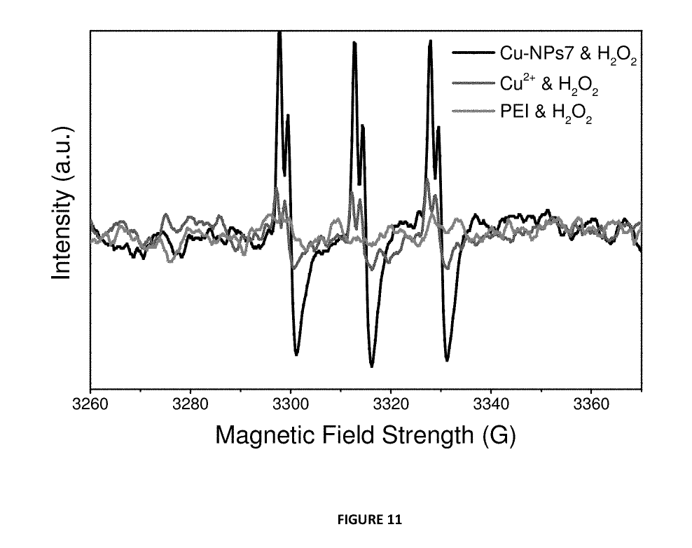

ESR was used to examine the dynamic and speciation of radical formation in the reaction. Basically, spin trap molecules react with free radicals in solution to form meta-stable nitroxyl radicals that produce a signal in ESR with intensity that depends on the radical concentration. Since hydroxyl/super oxide radicals have very short lifetimes (t_{1/2}˜μs-ns), they do not accumulate and the ESR signals depicted here represent a snapshot of the momentary generated radicals in the examined solutions. The synthesized Cu-NPs7 and H₂O₂ that rapidly degrade the atrazine demonstrated strong radical signals, while no signal was observed in solutions of Cu-NPs alone, H₂O₂ alone or PEI and H₂O₂ which did not degrade atrazine (FIG. 11, FIG. 3A). In Cu²⁺ ions and H₂O₂ solution, which did not demonstrate significant atrazine degradation activity, a weak signal (four times weaker signal than Cu-NPs7 and H₂O₂ signal) was observed.

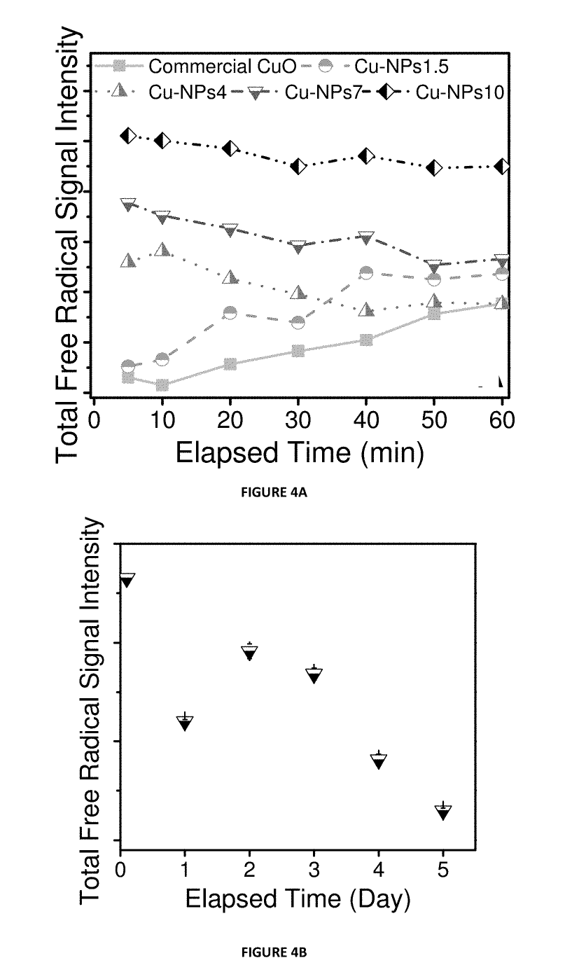

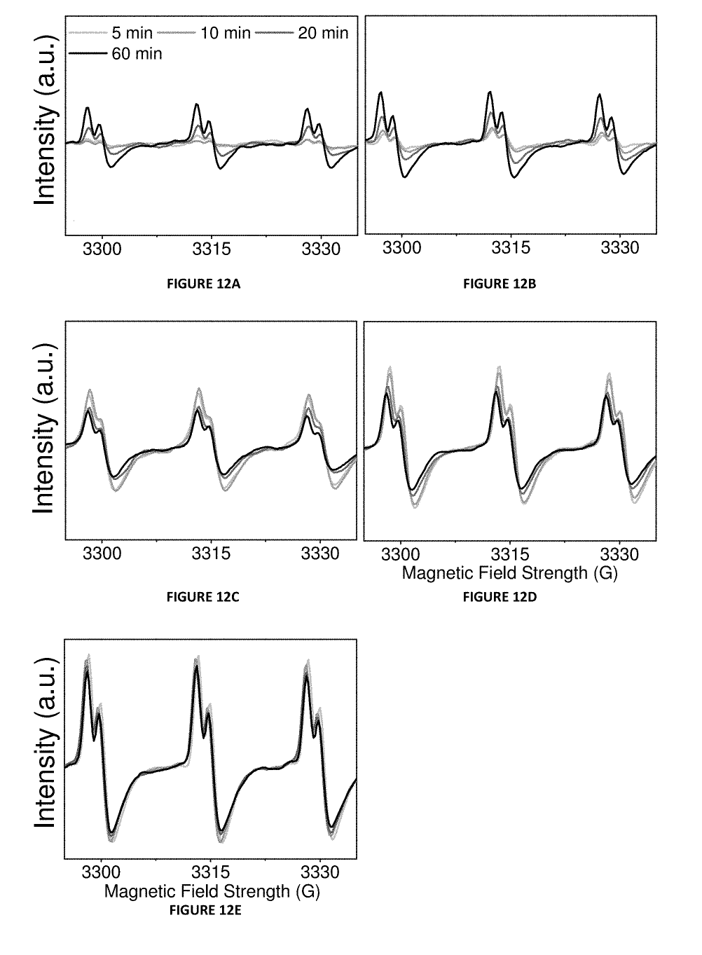

A different radical signal intensity and dynamic were observed during 1 h reaction of H₂O₂ with each of the Cu-NP/commercial CuO suspensions (FIG. 4A, FIGS. 12A-12E). Cu-NPs 4, 7, and 10 showed mild decreases in the generated radical signal intensity over time, while the signal of Cu-NPs1.5 and the commercial CuO that showed weak activity toward atrazine (FIG. 3B), increased continuously as the reaction progressed. Using the radical signal as an indication of the radical generation rate, and conducting rough integration of the signal amplitude during 1 h, it was demonstrated that the amount of total radical formed was in the following order: commercial CuO<Cu-NPs1.5<Cu-NPs4<Cu->NPs7<Cu-NPs10. This order resembles the trends of atrazine degradation experiments.

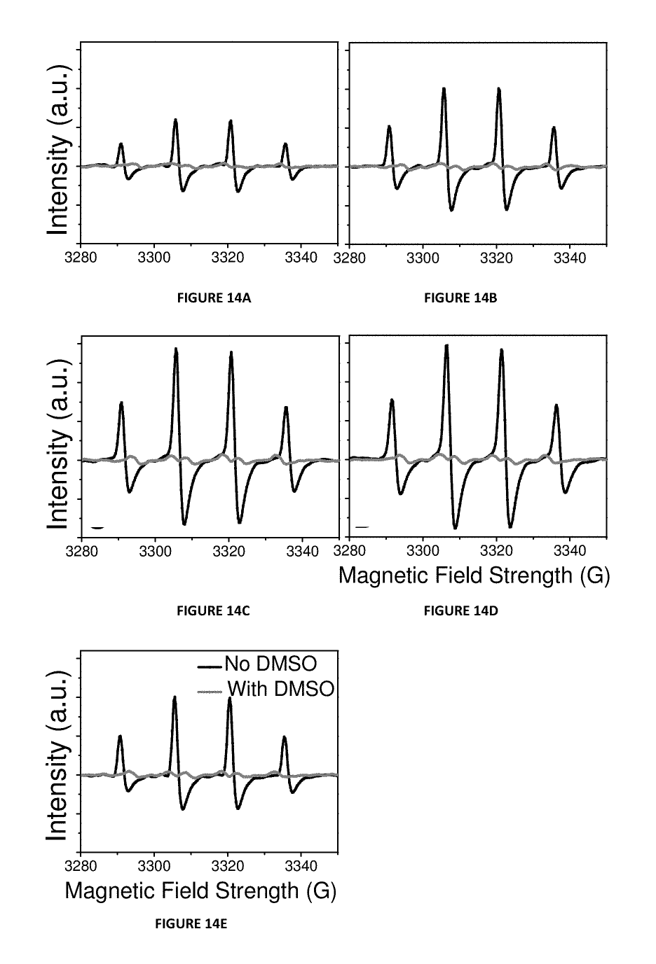

The radical type was studied rather than the radical formation intensity. The radical type may explain the different activity of the particles. DMPO reacts with different radicals such as hydroxyl and peroxide to give the same signal. Therefore its signal indicates the total radical formation without differentiation of the various radical species. DMSO is a selective hydroxyl radical scavenger and therefore it will quench the portion of DMPO signal resulting from hydroxyl radicals. The observation for all of the particles (FIGS. 14A-14E) demonstrated that when the DMSO was present, the DMPO signal was completely diminished. This means that the signal originated only from hydroxyl radicals and that they are the predominant type of radicals formed during the reaction.

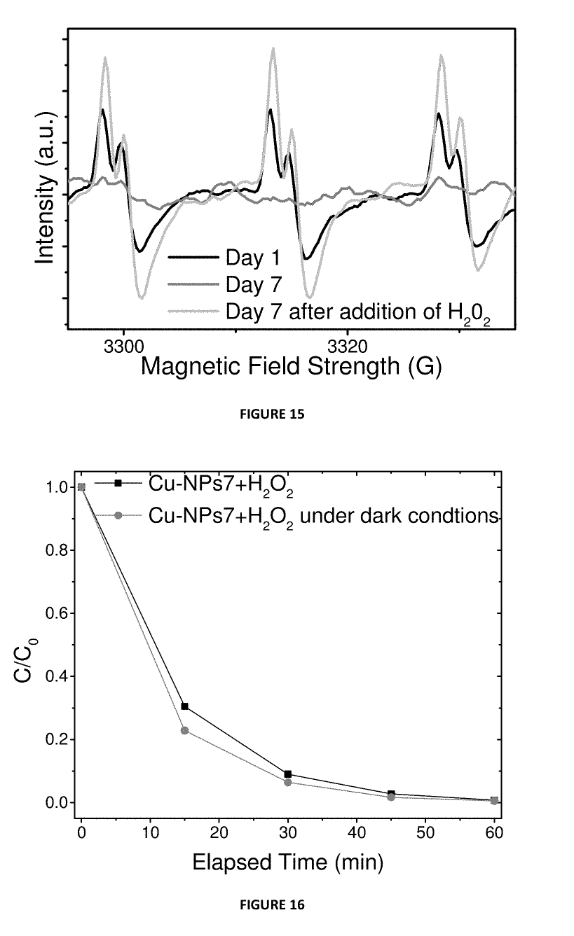

The intensity of the ESR signals of Cu-NPs7 and H₂O₂ solution decreased over the reaction time but could still be observed even 4 days after the reaction was initiated (FIG. 4B). This indicates continuous and prolonged generation of hydroxyl radicals by the Cu-NP catalysis. In order to understand whether the attenuation of the signal was related to consumption and reduction in concentration of H₂O₂ or due to degradation of the Cu-NP activity by poisoning, 1 mL of H₂O₂ was added to Cu-NPs7 and H₂O₂ solution that was exhausted after 7 days of reaction. The observed complete recovery of the ESR signal intensity (FIG. 15) demonstrated that the Cu-NPs were not poisoned and the lower formation rates of the hydroxyl radicals after several days of reaction are likely due to the consumption of H₂O₂. The long activity of the particles and the ability to regenerate the radical formation by addition of H₂O₂ indicates that activity of the Cu-NPs did not result from irreversible oxidation of the Cu⁰ or Cu¹⁺ to Cu²⁺ or dissolution of the particles.

### Example 4

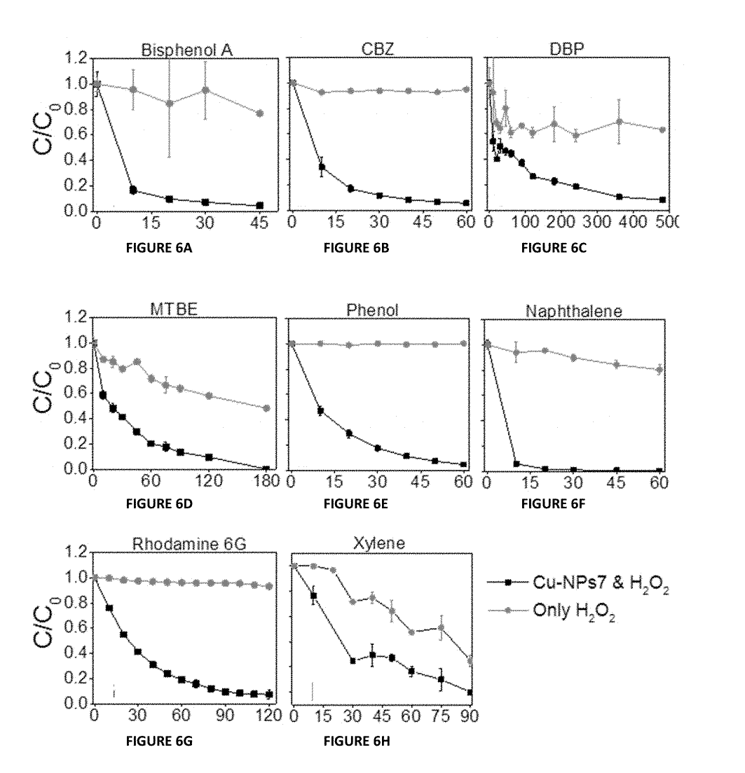

### Degradation of Different Organic Pollutants (FIGS. 6A-6H)

Methods:

The versatility of Cu-NP reactivity for a wide range of pollutant classes was demonstrated by the following experimental procedure and for the following model contaminants. Initially, stock solutions were prepared with 10 mg L⁻¹ naphthalene, or 50 mg L⁻¹ of bisphenol A, or DBP, or xylene, or 100 mg L⁻¹ MTBE. Then, 94.5 mL of the stock solution were mixed with 5 mL of 30% H₂O₂ and 0.5 mL of Cu-NP7 suspension (similar H₂O₂:Cu-NPs ratio as the atrazine experiments) and stirred (350 rpm) at ambient conditions for 4 h. As a control, the same ratio of stock solution:H₂O₂ was kept but without the addition of Cu-NP7 suspension. At predetermined time intervals, three samples of 2 mL of the mixed solution were collected and mixed with 2 mL of toluene or hexane in 4.5 mL Eppendorf in order to extract the contaminants into the organic phase. The Eppendorf was mixed by vortex and left for more than 4 h. Then, the organic phase was separated and was taken to gas chromatograph (GC; 5890 series II, Hewlett Packard (HP)).

Carbamazepine and phenol degradations were measured by HPLC (1 mL min⁻¹ flow rate) at wavelengths of 276 nm and eluents of 60%/40% acetonitrile/0.1% formic acid. The reaction was carried out with 100 μL of Cu-NP7 suspension, 1 mL of 30% H₂O₂ and 19 mL of carbamazepine (50 mg L⁻¹) or phenol (100 mg L⁻¹) solutions (similar ratio as for the atrazine degradation experiments). The attenuation of rhodamine 6G was measured with UV Vis spectrophotometer at a wavelength of 526 nm. To 19.9 mL solution of rhodamine with initial concentration of 4 mg L⁻¹, 100 μL of 30% H₂O₂ and 20 μL of the Cu-NP suspension were added and mixed. As a control, the same experiments were carried out but without Cu-NPs7 (only H₂O₂ was added to the contaminant solution).

Results:

The Cu-NPs demonstrated strong activity toward a wide range of organic pollutants. In FIGS. 6A-6H we show the degradation of the several chemicals representing different classes of well-known organic pollutants (carbamazepine, MTBE, xylene, naphthalene, phenol, Bis phenol A, DBP, rhodamine). All of these contaminants were almost completely removed (>90%) in less than two hours when Cu-NPs7 was employed as a catalyst and H₂O₂ as oxidation agent. DBP is the only exception with 8 hours to achieve >90% removal. H₂O₂ without the Cu-NPs demonstrated poor degradation performance. It is noted that some of the contaminants can be found in the environment at much lower concentrations than the one examined here; however, this work focused on demonstrating the strong activity of the Cu-NPs toward a wide range of contaminants.

### Example 5

### Effect of Light Using the Cu-NPs of this Invention (FIG. 16)

In order to understand whether the reaction is photo-reactive the same atrazine experiments as in Example 2 were conducted in dark conditions, when the glass vial was filled with atrazine (20 ppm) and H₂O₂ (1.5%) and Cu-NPs7 (0.25 mM as Cu²⁺), and covered with aluminum foil. As a control, the same experiment was conducted but without the aluminum foil (allowing exposure to light condition). The observed activity in dark conditions and the insignificant difference in atrazine degradation kinetics between dark and light conditions (FIG. 16) demonstrate that the Cu-NPs catalysis presented here is not a photo-dependent based reaction.

### Example 6

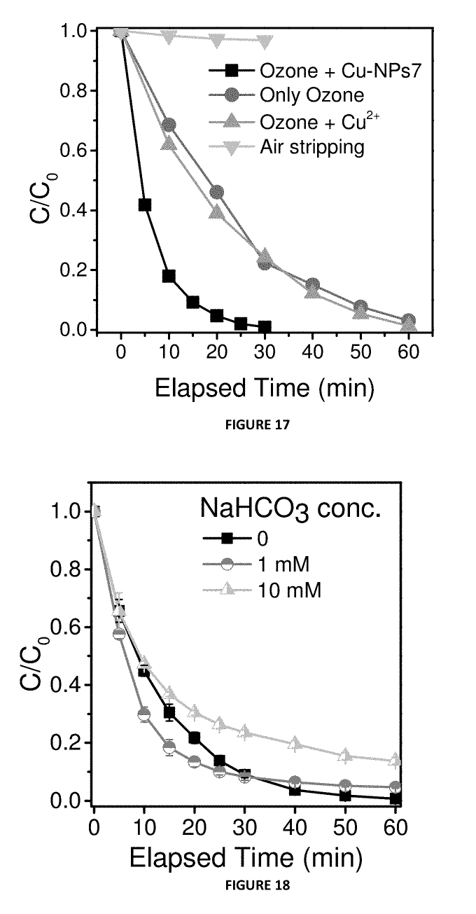

### Degradation of Organic Pollutants Using Cu-NPs of this Invention and Ozone (FIG. 17)

The activity of Cu-NPs when ozone was used as oxidant (instead of H₂O₂) was studied. Ozone was bubbled into 200 mL atrazine solution (20 ppm) without and with Cu-NPs7 or Cu²⁺ (both at concentrations equivalent to 0.25 mM Cu). The clear, faster atrazine degradation rate when Cu-NPs7 was introduced with ozone, as compared to ozone alone or ozone+Cu²⁺ (FIG. 17), demonstrates the Cu-NP better activity with ozone.

### Example 7

### Degradation of Organic Pollutants Using Cu-NPs of this Invention in Different Salts (FIGS. 18-20)

Methods:

atrazine degradation by Cu-NPs7 and H₂O₂ was examined under different solution compositions. Atrazine solutions (20 mg L⁻¹) were spiked with 0.5 M NaCl. Then, 1 mL H₂O₂ and 100 μL of Cu-NPs7 were added to 19 mL of both solutions (with and without spiking) to give final concentration of atrazine: 19 mg L⁻¹, 1.5% H₂O₂, and Cu-NPs7 in concentration equivalent to 0.25 mM as Cu). Two NaCl concentrations of 0.5 M (similar to seawater concentration) and 0.05M (similar to brackish water) were prepared (by mixing the above solutions) and tested for atrazine degradation. Each solution was mixed for 1 h (350 rpm), and then atrazine concentrations were measured by HPLC. A similar procedure was used for atrazine solutions (20 mg L⁻¹) spiked with 50 mM humic acid or 10 mM NaHCO₃ instead of NaCl. Concentrations of 50 mM and 10 mM of humic acid or 1 mM and 10 mM of NaHCO₃ in the solution with H₂O₂ and Cu-NPs7 were also tested for degradation of atrazine.

Results:

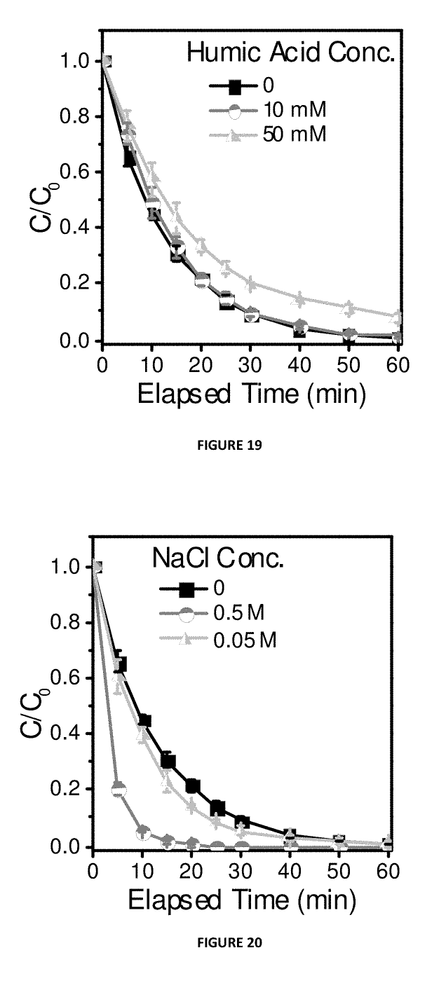

The presence of NaHCO₃ (FIG. 18) and humic acid (FIG. 19) led to moderately lower atrazine degradation rates only at the high concentration (10 mM and 50 mM, respectively), compared to a deionized water solution. However, the presence of NaCl (FIG. 20) accelerated atrazine degradation kinetics. At a high concentration of 0.5 M NaCl, atrazine concentrations were reduced by 95% in 10 min of reaction compared to 55% in 10 min for deionized water based solution.

### Example 8

### Preparation of Cu-NPs Incorporated into Clay or Sand

Preparation of the Sand/Clay_Cu-NPs:

Known amounts of sand and clay were activated in an oven for 2 h at 150° C. and stored in glass vials for further use. Known amounts of activated sand and montmorillonite K10 (MK10) (5 g) were sonicated with 20 mL of Cu-NPs4 or Cu-NPs4-b solution by slow addition followed by 12 h stirring. The product was then filtered, washed with excess of water until the supernatant became neutral pH, and dried in an oven at 60° C. A known weight of the prepared materials (before and after the atrazine degradation) was treated with acidic water (0.1% HNO₃) to quantify the concentrations of copper with an inductive coupled plasma mass-spectrophotometer (ICP-MS, Model: Agilent 7700).

Characterization:

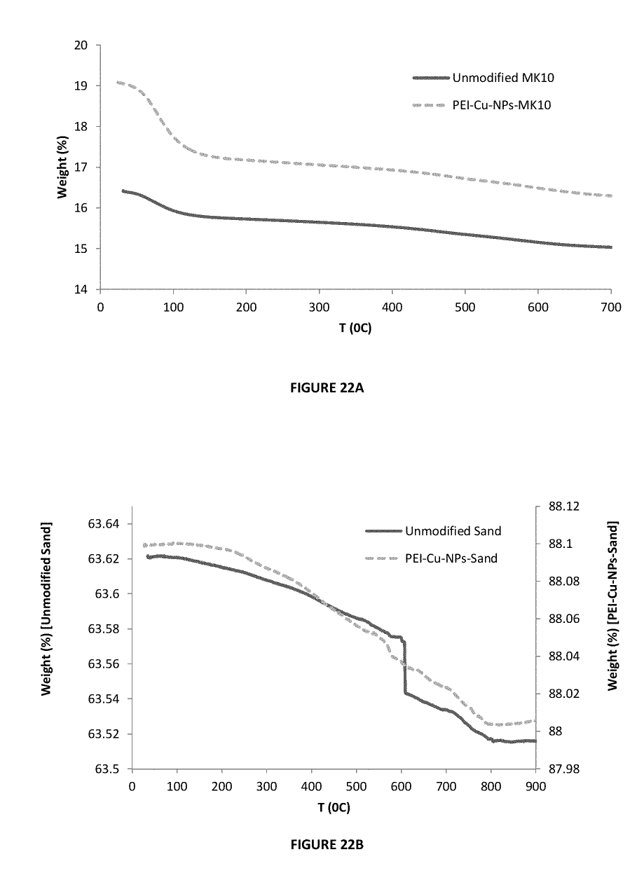

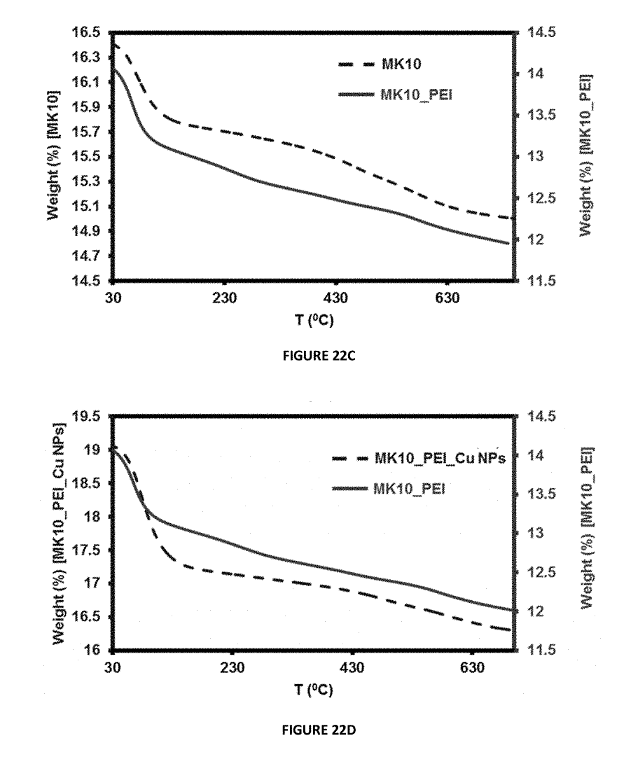

The thermogravimetric analysis (TGA) pattern of both MK10 and sand was clear and different thermal degradation patterns were observed for both modified and unmodified MK10 (FIG. 22A) and sand (FIG. 22B). According to TGA measurements, the initial degradation occurred due to the low volatile organic compounds and moisture. The major difference in the degradation pattern in the range of 300-400° C. confirms the presence of PEI-Cu-NPs in modified MK10 and sand. TGA data also showed that the PEI-Cu-NPs decomposed at lower temperature than the free PEI. Further, the TGA pattern of PEI alone with MK10 is shown in (FIGS. 22C-22D); PEI has two degradation temperatures, at 330° C. and 370° C. Similarly, the thermal conversion of copper was also achieved from 300° C. The remaining small changes arose due to the MK10 and sand composition. The following features were found for the resulting PEI-Cu-NPs incorporated on sand and clay:

The PEI-Cu-NPs incorporated on sand and clay enable easy reuse;

Without the clay and sand, the PEI-Cu-NPs are suspended; and

The PEI-Cu-NPs incorporated in sand or MK10 do not precipitate even after one month.

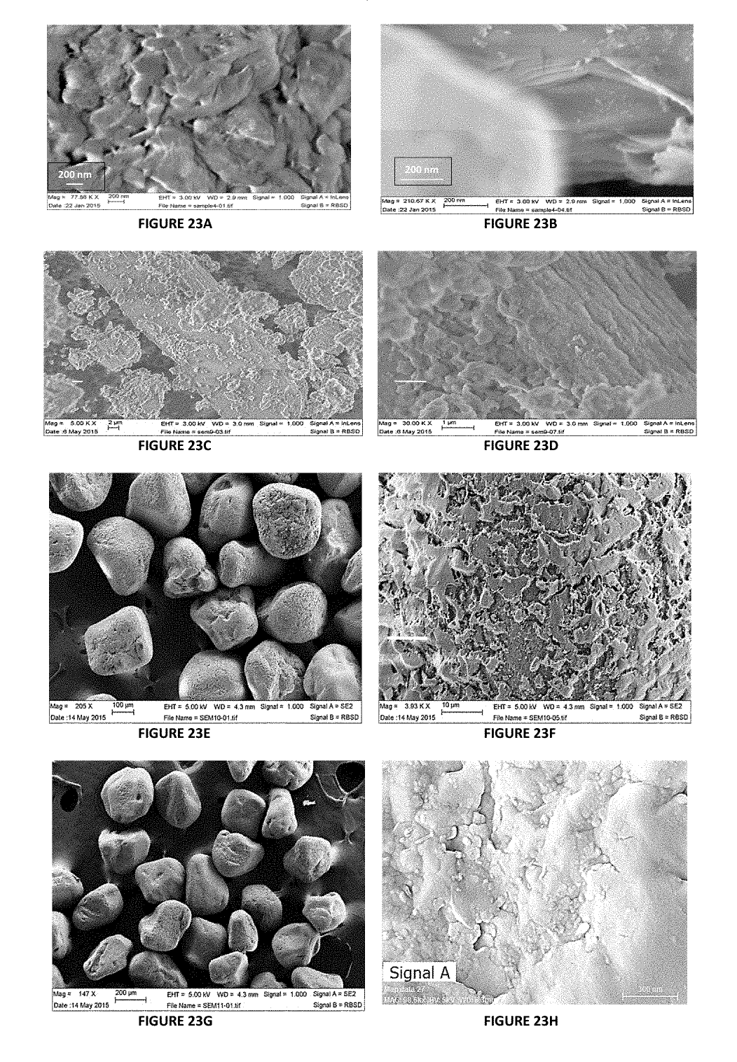

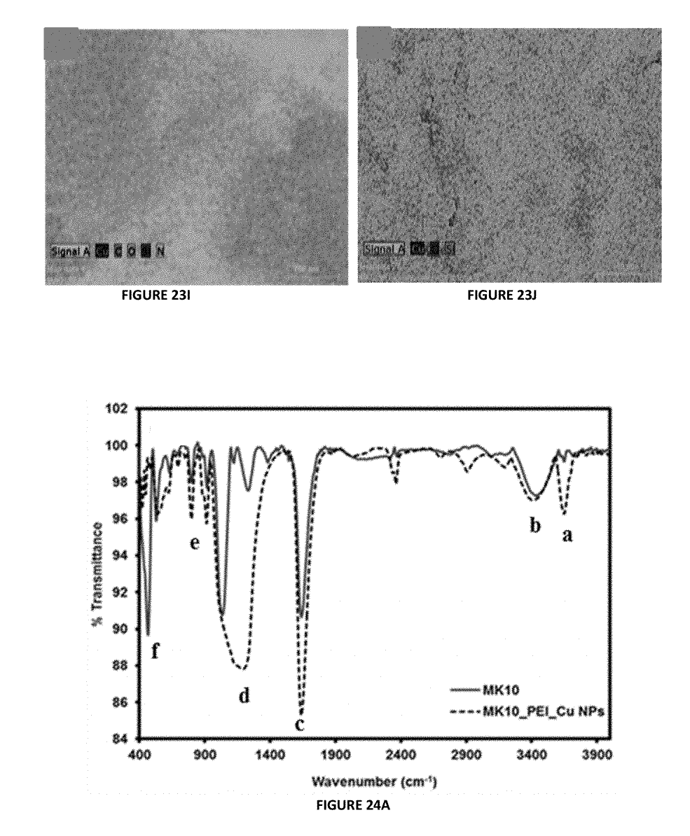

The PEI-Cu-NPs-sand/MK10 composites structures were confirmed with scanning electron microscopic (SEM) analysis. SEM images (FIGS. 23A-23J) of modified clay showed (FIGS. 23C and 23D) some exfoliation of layer sheets as well as non-exfoliated MK10 matrix, however the unmodified MK10 showed layer structures (FIG. 23A-23B). The exfoliation arises due to the incorporation of PEI-Cu-NPs. In sand, the PEI-Cu-NPs are incorporated into pores of the sand and PEI-Cu-NPs exist as disc shaped (FIG. 23G-23H), different from the features found in the unmodified sand (FIG. 23E-23F). Energy Dispersive Spectrum (EDS)—not shown here—confirmed the presence of copper in the modified sand and MK10. Elemental mapping confirmed the distribution of copper and nitrogen on the PEI-Cu-NPs incorporated into MK10 and sand (FIG. 23I-23J).

The FT-IR spectra of unmodified MK10 and sand were compared to the same material with Cu-NPs (see FIG. 24A-24B). Table 1 shows the significant peak areas of MK10_Cu-NPs. The spectrum of the MK10_Cu-NPs shows signals of all constituents of the reactant materials (PEI and Cu), which confirms the incorporation of Cu-NPs onto the solid matrix (FIG. 24A and Table 1). Primarily, the broad and strong band ranging from 3000 to 3800 cm⁻¹. can be assigned to overlapping —OH and —NH groups (marked as area a). The band 2840-3000 cm⁻¹ denotes the asymmetric and symmetric C—H stretching frequencies of the —CH₂ group in PEI chains (marked as area b in FIG. 24A).

TABLE 1

| Wave | | |
|---|---|---|
| number | | |
| (cm⁻¹) | Description | Spot |
| 3300-3630 | Ionic bonded N—H stretching and O—H stretching of | a |
| | structural hydroxyl group from clay | |
| 2850-2960 | C—H asymmetric stretching | b |
| 1650 | O—H deformation of entrapped water in clay and | c |
| | N—H bending | |
| 950-1450 | Si—OH vibration, Si—O in-plane stretching, CH₃ | d |
| | rocking, overlap of C—C stretching, CH₂ twisting, | |
| | C—N stretching, CH₂ rocking and skeletonic | |
| | stretching | |
| 820-920 | Al—Al—OH deformation, C—H bending out of plane | e |
| | and C—C skeletonic stretching | |
| 400-800 | Si—O stretching of quartz and silica, Si—O | f |
| | deformation perpendicular to optical axis, Si—O | |
| | deformation parallel to optical axis, Si—O—Si | |
| | deformation, CH₂ rocking, N—H out of plane | |
| | wagging, C—C bending and copper oxide. | |
| | NOTE: Coupled Al—O and Al—O—Si deformation | |
| | are found only in unmodified and modified MK10. | |

The broader peak in the spectral range 400-800 cm⁻¹ relative to the unmodified clay (marked as area f in FIG. 24A) was observed. The broadening might be due to the bulkier organic moiety from PEI (CH₂ rocking, N—H out of plane wagging, C—C bending) and copper oxide (vibrational modes of the Cu—O bond, 479.8 and 585.6 cm^{-r}), which may suggest more noncovalent interaction with MK10. Additionally, a change in the peak intensity (Al—Al—OH deformation, 820-920 cm⁻¹, marked as area e in FIG. 24A) after modification was observed. The increase in the intensity of the peaks in the spectral range (820-920 cm⁻¹, marked as area e in FIG. 24A) after Cu-NP incorporation onto MK10 are possibly due to the addition of organic moieties (C—H bending out of plane and C—C skeletonic stretching) from PEI.

A significant increase in peak height and broadening in the spectral range (950-1450 cm⁻¹, Table 1) for modified MK10 was observed, which is due to the amine (C—N—Hₙ) peak in noncovalent interaction with neighboring functional group (marked as area d in FIG. 24A). These changes are additional confirmation that Cu-NPs are incorporated onto MK10. The strong absorption band at ˜1048 cm^{-bs}(marked as area c in FIG. 24A) is the uniquely characteristic vibration of Si—O, Si—O—Si in the clay lattice, CH₃ rocking, overlap of C—C stretching, CH₂ twisting, C—N stretching, CH₂ rocking and skeletonic stretching. Moreover, the increased peak intensity at ˜1630 cm^{-s} is also assigned to the O—H deformation of entrapped water in clay and N—H bending from PEI, indicating the incorporation of Cu-NPs (marked as area c in FIG. 24A).

For sand_Cu-NPs, very weak peak changes in the spectrum when comparing the unmodified and modified sand (see FIG. 24B) was observed. Nevertheless, significantly smaller peak changes (similar peak positions, marked as area a-f in FIG. 24B) were noticed due to the smaller amount of Cu-NPs incorporated onto sand than onto MK10 (as confirmed by the elemental mapping—see FIGS. 23A-23J). Further, weak peak changes and broadening are possibly by overlapping the other spectral peaks of copper oxide, hydroxyl, amine, asymmetric/symmetric C—H stretching frequencies of the —CH₂ group in PEI chains with Si—O and Si—O—Si from sand in the fingerprint region (marked as c-f in FIG. 24B), as well as in the main functional group region (marked as a, b in FIG. 24B).

The incorporation of the Cu-NPs onto MK10 and sand was analyzed also with powder XRD; the results are shown in FIG. 28. Additional peaks were observed correlated to Cu₂O and CuO species (star and circle symbols) found in Cu-NPs incorporated onto MK10 and sand (Cheng, S. L. & Chen, M. F. Fabrication, characterization, and kinetic study of vertical single-crystalline CuO nanowires on Si substrates. Nanoscale Res Lett. 7, 119-125 (2012). The XRD pattern of MK10_Cu NP material shows pointed diffraction peaks at 2θ values corresponding to 18.14°, 20.73°, and 22.79°, which indicate the crystalline nature with a certain degree of exfoliation.

### Example 9

### Degradation of Atrazine Using PEI-Cu-NPs Incorporated into MK10 and Sand

A stock solution of atrazine (1000 mg L⁻¹; in 0.1% (v/v) methanol) was prepared and stirred with 30 mg of PEI-Cu-NPs incorporated into MK10 or 30 mg PEI-Cu-NPs incorporated into sand, 20 mg L⁻¹ of atrazine, 20 μL of H₂O₂ (30%) at pH range of 6-7 for 60 min in 20 mL volume. The entire reaction mixture was stirred at 350 rpm for 1 h under open atmospheric conditions.

The kinetics of the reaction were measured at each predetermined time interval, 1 mL of the solution was filtered through a 0.22 μm microfiltration disk (PVDF-0.22 μm, Millex-GV, Milipore) and 25 μL of the filtrated solution was injected to high pressure liquid chromatograph (HPLC; 1525 Binary HPLC Pump, Waters) with UV detector (2487 Dual λ Absorber Detector, Waters) measured at λ=222 nm. Eluent (75% acetonitrile:25% DI or DCM or 50% water:50% methanol) flow rate was 1 mL min⁻¹ with pressure of ˜1500 psi. The same procedure was conducted for 20 mg L⁻¹ of atrazine that was dissolved in tap water instead of DI water.

The other analytical parameters were optimized such as different concentrations of H₂O₂, dosage, concentration of atrazine and time.

Also, in other experiments, the same procedure was followed for the unmodified MK10, sand and liquid PEI-Cu-NP solutions.

In all of the above kinetic experiments, the reaction mechanism (adsorption or degradation) of the reaction between the prepared materials and atrazine was examined by treating the solid material with eluent (75% acetonitrile:25% DI or DCM or 50% water:50% methanol) (10 mL) for 12 h, which was obtained after the reaction. After the elution, the 10 mL eluent was analyzed in UV-vis spectrophotometer, showing a small, broad peak between 235 and 270 nm indicative of low molecular weight metabolites that were produced due to atrazine degradation.

In addition, the supernatant after the reaction was subjected to UV-vis spectrophotometric analysis to check leachability of PEI-Cu-NPs from the modified MK10 and sand.

Results:

There was no UV-vis spectrophotometric peak for PEI-Cu-NPs for the supernatant after the degradation of atrazine. This confirms that no leaching of PEI-Cu-NPs from the modified MK10 and sand occurred. Furthermore, no UV-vis spectrophotometric peak was observed for PEI-Cu-NPs, and ICP (less than 0.02% of Cu from the catalyst in the supernatant after the degradation of atrazine were identified.). This confirms that there was no significant leaching of PEI-Cu-NPs or copper from the MK10_PEI-Cu-NPs and sand_PEI-Cu-NPs after the atrazine degradation. The small percentage of copper found in the supernatant is attributed to the effect of the reaction pathway, unprotected copper by PEI (anchored in terminal amino groups in the PEI) and PEI-Cu-NPs surrounded on the exfoliated clay layers or on the sand surface, respectively. This may lead to the loss of a very small amount of PEI during the degradation reaction.

This finding is a clear indication of some relatively weak force that attaches the copper particles to the amine groups (primary, secondary, tertiary). However, it is also noted that PEI-Cu supramolecular polymer networks are capable of reversible self-repair (from the mechanical damage on PEI-Cu polymer networks caused by stirring and peroxide) by the reformation of Cu—N coordination bonds (Wang, Z. & Urban, M. W. Facile UV-healable polyethylenimine-copper (C₂H₅N—Cu) supramolecular polymer networks. Polym Chem. 4, 4897-4901 (2013)). In conclusion, the small amount of leachable copper and increased PEI-Cu stability are due to PEI-Cu stoichiometry, in which primary, secondary, and tertiary amines are present; this facilitates additional network integrity, capability and physicochemical support from the host matrixes (MK10 and sand) during the degradation.

The reaction was carried out at pH 6; pH remains unchanged even after the reaction. The effluent supernatant did not required any further treatment.

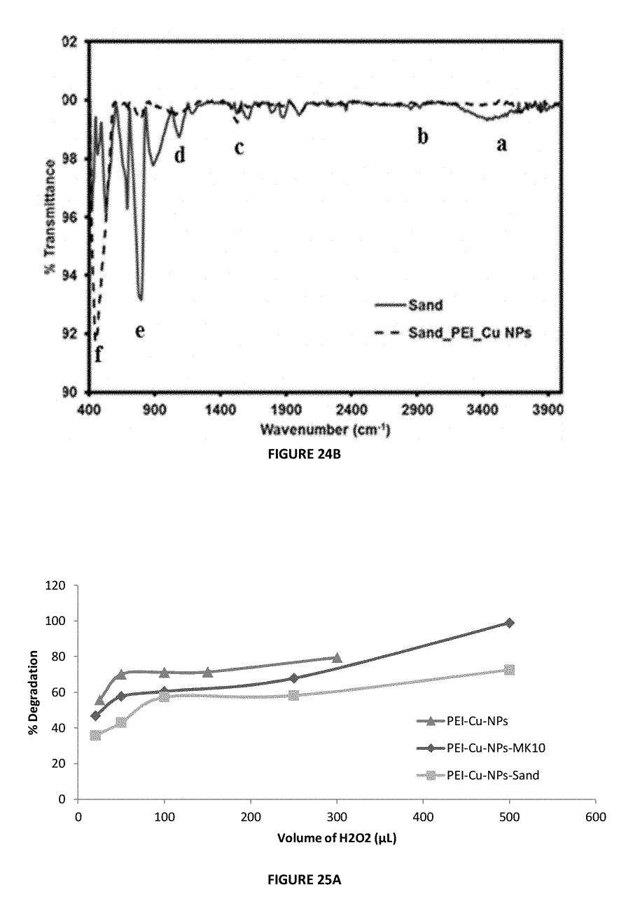

The percentage degradation of atrazine with respect to the change in the volume of hydrogen peroxide against the PEI-Cu-NP solution, and also with PEI-Cu-NPs immobilized in clay (MK10) and sand is given in FIGS. 25A and 25B. PEI-CuO NPs shows the faster and higher degradation at 300 μL but the PEI-Cu-NPs incorporated in MK10 and sand show complete degradation with 500 μL of H₂O₂ in 1 h (FIG. 25A). FIG. 25B presents complete degradation after 15 h with the 300 μL, 500 μL, and 500 μl, respectively, for PEI-Cu-NPs, MK10_PEI-Cu-NPs and sand_PEI-Cu-NPs. In addition, maximum degradation (>94%) was achieved within 15 h with 20 μL of peroxide (from 30% H₂O₂) in MK10_PEI-Cu-NPs and sand_PEI-Cu-NPs composites. The PEI-Cu-NP solution presented a maximum of 96% degradation after 15 h and 45% degradation after 1 h.

Control experiments, utilizing the catalyst MK10, MK10_PEI-Cu-NPs, sand or sand_PEI-Cu-NPs, were conducted without the addition of H₂O₂ and did not show any degradation of the atrazine; rather, the atrazine compound was only adsorbed in these cases.

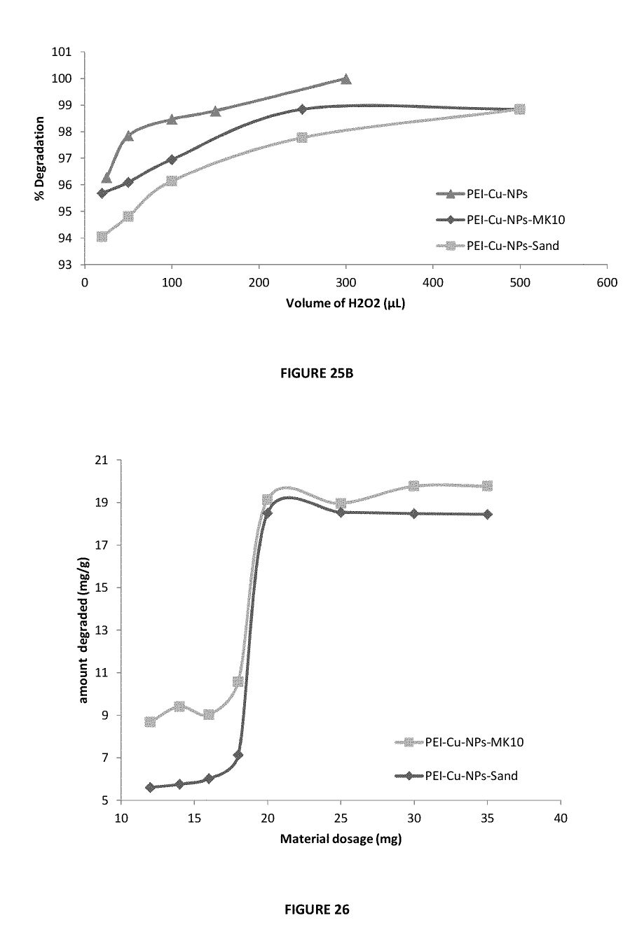

The maximum degradation was achieved at 30 mg of material dosage (FIG. 26). There was gradual increase in the % of degradation up to 16 mg. Thereafter, there was a sharp increase in the degradation and then immediate, complete degradation.

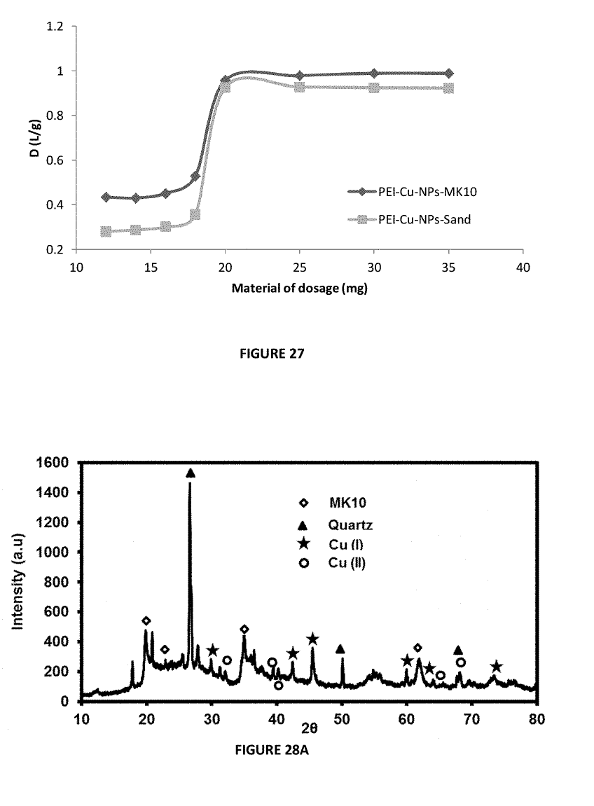

The homogeneity of the incorporation (distribution) of PEI-Cu-NPs (on the MK10 and sand) was obtained from plot of adsorbent dosage against distribution capacity for atrazine (FIG. 27). In this case, it was assumed that the amount of atrazine degraded is similar to that amount adsorbed.

Unmodified clay and sand showed only adsorption of atrazine, which was confirmed by elution with 50% v/v methanol-water mixture. The eluted mixture was analyzed by UV-vis spectrophotometer. Modified sand/MK10_PEI-Cu-NPs materials did show adsorption, in the presence of H₂O₂. This can be desorbed back into solution and measured by solvent extraction.

Finally, COD experiments were carried out with AQUANAL™-professional tube test COD (0-150 mg L⁻¹). For experiments in the COD test tube, a known volume of supernatant after the atrazine degradation was added to 1 mL of Na₂CO₃ (50 mg L⁻¹) and the entire reaction mixture was refluxed at 150° C. for 2 h, followed by cooling and subjected to UV-vis spectroscopic analysis. The samples were covered to minimize evaporation losses and heated in water. Here, sodium carbonate was used to prevent the peroxide from interfering in measurement of COD (Wu, T. & Engelhardt, J. D. A New Method for Removal of Hydrogen Peroxide Interference in the Analysis of Chemical Oxygen Demand Environ Sci Technol. 46, 2291-2298 (2012)). Earlier, calibration was done with KHP as above in the concentration range of 15 to 125 mg L⁻¹. The observed COD value for atrazine solution before degradation (control experiment), after the degradation with PEI-Cu NPs, MK10_PEI-Cu-NPs and sand_PEI-Cu-NPs were 173.62 (control), 83.91, 55.41 and 72.67 mg O₂/L respectively. All three samples (PEI-Cu NPs, MK10_PEI-Cu-NPs and sand_PEI-Cu-NPs) degrade COD to below 100 (the preferred general upper limit by many regulatory agencies, when examining industrial effluents). The MK10 (clay) “version” yields the most significant drop in COD.

The results are further presented in the following Table:

| Sample | | COD |
|---|---|---|
| No | Sample | (mg O₂/L, average of 3) |
| 1 | 20 mg/L atrazine | 173.62 |
| | (before degradation) | |
| | (CONTROL) | |
| 2 | PEI-Cu-NPs suspension | 83.91 |
| | (after atrazine degradation) | |
| 3 | MK10_PEI-Cu NPs | 55.41 |
| | (after atrazine degradation) | |
| 4 | Sand_PEI-Cu-NPs | 72.67 |
| | (after atrazine degradation) | |

### Example 10

### Effect of Hydrogen Peroxide in the Catalytic Degradation of Atrazine by MK10/Sand_Cu-NPs

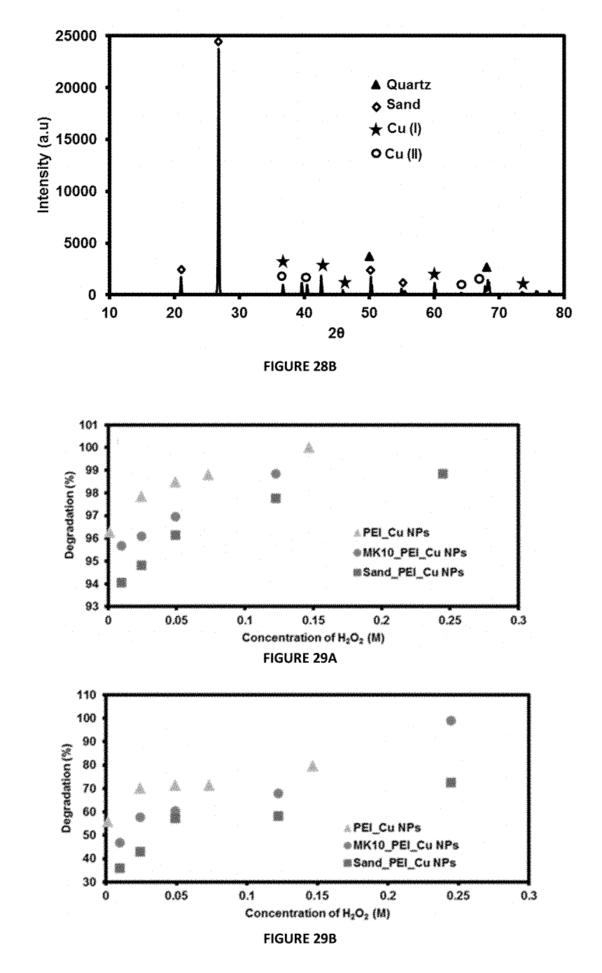

The effect of hydrogen peroxide (30%) concentration (0.0098-0.245 M of H₂O₂ in 20 mL volume) on atrazine degradation was studied for a PEI-Cu-NP suspension (100 μL), and for addition of 10 mg of MK10_PEI-Cu-NPs and sand_PEI-Cu-NPs. Results are depicted in FIG. 29A, 29B. The PEI-Cu-NP suspension showed maximum degradation (44.8% after 1 h; 77% after 15 h) with addition of 20 μL of hydrogen peroxide (0.0098 M). MK10_PEI-Cu-NPs and sand_PEI-Cu-NPs showed complete degradation with 500 μL (0.245 M) of H₂O₂ in 1 h (FIG. 29A). This clearly indicates that the rate of atrazine depends on the copper nanoparticles and their contact time with atrazine. To evade the generation of excess radicals after the degradation reaction, the atrazine degradation with lower concentration of hydrogen peroxide (0.0098 M) was studied. >94% and >35% degradation of atrazine after 15 h and 1 h respectively was observed. Furthermore, to reduce the longer kinetics of degradation (15 h) and keep the lower concentration of H₂O₂, degradation can be achieved by increasing the number of catalytic reactive sites (i.e., varying the amount of catalyst supply as discussed below).

### Example 11

### Effect of Catalyst Dosage in the Catalytic Degradation of Atrazine by MK10/Sand_Cu-NPs

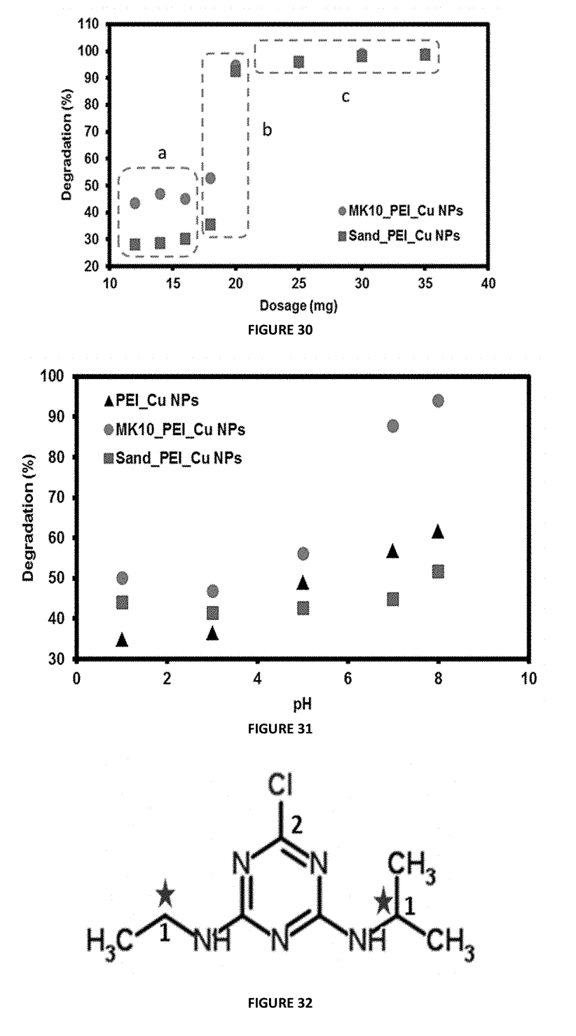

Batch experiments were conducted to investigate the effect of dosage of PEI-Cu-NPs incorporated onto sand and MK10, on atrazine degradation (20 mL of 20 mg L⁻¹), by varying dosages in the range of 12-35 mg (which includes the PEI-Cu-NPs and MK10/sand); results are shown in FIG. 30. Initially, the degradation amount in both cases increased slowly by ˜10%, and the rate of degradation remained low until 18 mg of the catalyst were added (marked as area a). This is possibly due to noncovalent interactions between the catalyst and atrazine, which hinder contact between H₂O₂ and the copper. A sharp increase in the amount of atrazine degradation (to ˜95%, marked as area b) was observed, when the amount of catalyst increased between 18-20 mg. This is due to increased availability of reactive sites and the existence of more PEI-Cu-NPs, as well the synergistic influence on the breaking of the stable transition complex between the catalyst and atrazine (as mentioned earlier). Furthermore, when the amount of added catalyst was raised from 20 mg to 30 mg, no significant (after 20 mg catalyst dosage) increase in the percentage of atrazine degraded (marked as area c).

### Example 12

### Effect of pH in the Catalytic Degradation of Atrazine by MK10/Sand_Cu-NPs

The influence of pH on atrazine degradation with PEI-Cu-NPs, modified MK10 and sand was also studied. The pH of the reaction mixture was adjusted with different acids (HCl, H₂SO₄ and H₃PO₄) and bases (NaOH and K₂HPO₄). The pH remained constant throughout the experiments. In all cases, maximum (>99%) degradation of atrazine was observed (this is comparable to regular Fenton type reactions; therefore no plots were shown). Different patterns and percentages of atrazine degradation were observed when the solution was treated with H₃PO₄ and K₂HPO₄ (FIG. 31). This distinct behavior of H₃PO₄ and K₂HPO₄ adjusted solution pH versus atrazine degradation is discussed hereafter.

The PEI-Cu-NP suspension, modified clay and sand show different percentages of atrazine degradation and various patterns (FIG. 31), when plotting atrazine degradation vs. solution pH (adjusted with H₃PO₄). The modified MK10 shows a sigmoidal type curve (FIG. 31) and a maximum degradation of 87.8%; modified sand and PEI-Cu-NP suspensions showed a different degradation pattern with lower degradation rates (44.9% and 63.7%, respectively). The lower atrazine degradation may be influenced by the ionic species from H₃PO₄ and its affinity to copper. Furthermore, the steric interference from aliphatic chain (from PEI) in PEI-Cu-NPs cannot be ignored as a factor affecting the degradation.

With this pH condition (optimized by K₂HPO₄), the reaction was faster for alkaline pH (8>7>>6 . . . ); this seems to be opposite to the “classical” Fenton reaction, where (strong) acidic conditions are needed. This behavior may possibly be due to the presence of Cu²⁺, originating from copper (II) phosphate. Here, the copper ion can easily be freed for the oxidative degradation reaction.

The structural steric hindrance in atrazine is larger for the carbon next to the ethylamine group (FIG. 32), because it does not have chains (alkyl group) that are difficult to break, and it is also one carbon short with respect to the alkylamine (Pulkkinen, P. et. al. Poly(ethylene imine) and Tetraethylenepentamine as Protecting Agents for Metallic Copper Nanoparticles. ACS Appl Mater Interface 1, 519-525 (2009)).

Therefore, MK10 and sand_PEI-Cu-NPs likely degrade the atrazine through one of the following mechanisms: (i) protonation of the amino group, then the aromatic ring, followed by the breaking of a C—Cl bond; (ii) direct nucleophilic displacement of Cl by an hydroxyl group, and (iii) a radical mechanism involving replacement of the chlorine atom by an hydroxyl group, followed by reduction of the amino group and oxidation of the alkyl group (Mami án, M. Torres, W. & Larmat, F. E. Electrochemical Degradation of Atrazine in Aqueous Solution at a Platinum Electrode. Portugaliae Electrochimica Acta 27, 371-379 (2009)).

### Example 13

### Removal Dynamics (Adsorption Vs. Degradation) in the Catalytic Degradation of Atrazine by MK10/Sand_Cu-NPs

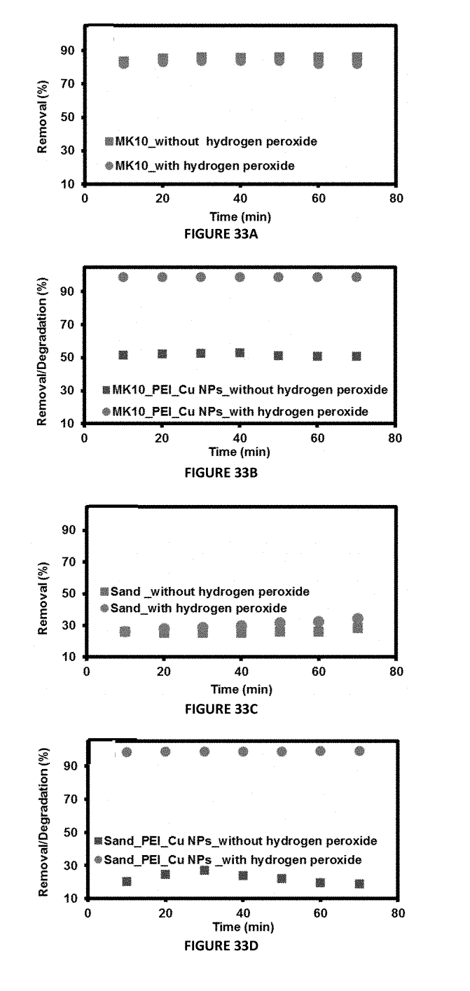

To verify the atrazine removal process (adsorption or degradation) by our prepared materials, we followed the same optimum reaction conditions as described in example 9. The results are shown in FIGS. 33A-33D: atrazine adsorbed (and was not degraded) at least partially on both modified and unmodified MK10 and sand surfaces, in the absence of hydrogen peroxide, which was verified by elution study (as mentioned in UV spectrophotometric analysis section). For modified MK10 and sand, atrazine molecules can interact relatively strongly with copper, due to the presence of heteroatoms (N) with free electron pairs and aromatic rings with delocalized π electrons (Decock, P. et. al. Cu(II) binding by substituted 1,3,5-triazine herbicides. Inorg Chim Acta 107, 63-66 (1985)). The unmodified MK10 showed only adsorption in the presence and absence of H₂O₂, after a reaction time of 60 min the atrazine concentration in solution was reduced by 85.94% and 82.12% (FIG. 33A). It has been noted that atrazine adsorption (not degradation) on unmodified MK10 is significantly higher than adsorption on modified MK10 (FIG. 33B), in the absence of hydrogen peroxide, due to the dominance of atrazine adsorption through noncovalent interactions on the less crowded MK10 surface (Herwig, U., Klumpp, E., Narres, H. D. & Schwuger, M. J. Physicochemical interactions between atrazine and clay minerals. Appl Clay Sci 18, 211-222 (2001)). This may be due to the presence of both Bronsted and Lewis acidic active sites on MK10. The interlayer cations are exchangeable, thus allowing alteration of the acidic nature of the material by simple ion-exchange procedure (Zhou, C., Li, X., Li, Q. & Tong, D. Synthesis and acid catalysis of nanoporous silica/alumina-clay composites. Catal Today 93-95, 607-613 (2004)). A similar pattern of atrazine removal (but with a much lower removal rate) was observed for unmodified sand (34.28% and 28.38%, FIG. 33C, 33D). Atrazine adsorption in all of the above cases was verified by elution. Similarly, the kinetics of atrazine degradation by modified MK10 and sand were also studied in the presence and absence of H₂O₂. The results are shown in FIG. 33B, 33D. When the equilibrium time was increased, the degradation level raised gradually in the presence of H₂O₂. Maximum degradation of atrazine for both systems was observed after 60 min, beyond which there was almost no further increase in degradation, for both MK10_PEI-Cu-NPs and sand_PEI-Cu-NPs; this can thus be fixed as the optimum contact time.

### Example 14

### Kinetics of Catalytic Degradation of Atrazine by MK10/Sand_Cu-NPs

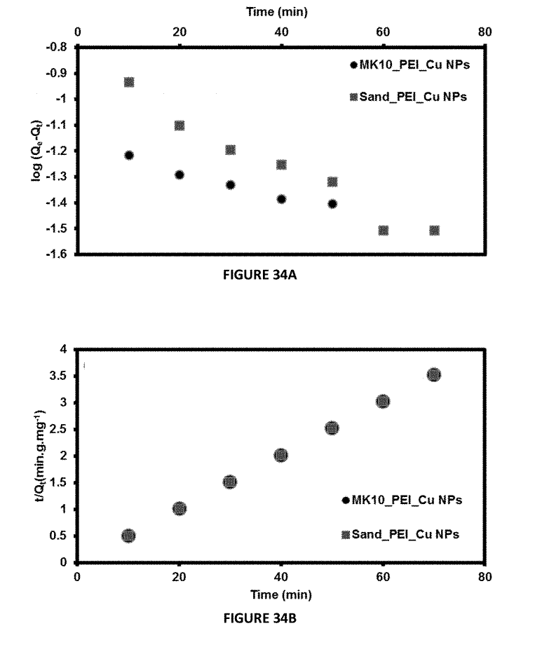

The degradation of atrazine for all treatments discussed previously (example 9) was rapid (60 min); this may arise due to the affinity of atrazine for the mineral surfaces (Decock, P. et. al. Cu(II) binding by substituted 1,3,5-triazine herbicides. Inorg Chim Acta 107, 63-66 (1985)) at circumneutral pH, and followed by its degradation in the presence of H₂O₂. The rate of atrazine degradation (20 mg L⁻¹) was examined over time (10-70 min with 10 min interval). To investigate the degradation mechanism, first-order (equation 1) and second-order (equation 2) models were used to fit the experimental data:

$$\begin{matrix}log ( {Q}_{e} - {Q}_{t} ) = log {Q}_{e} - {K}_{1} \times \frac{t}{2.303} and & ( 1 ) \\ \frac{t}{{Q}_{t}} = \frac{1}{{K}_{2} {Q}_{e}} + \{ {K}_{2} \times \frac{t}{{Q}_{e}} \} & ( 2 )\end{matrix}$$

where Qₑ and Qₜ (mg g⁻¹) are the amounts of atrazine degraded per unit mass of catalyst at equilibrium and time t (min), respectively, and K₁, and K₂ are the first- and second-order rate constants. The plots (FIGS. 34A-34D) of log (Qe-Qt) versus t (FIG. 34A) and t/Qt versus t (FIG. 34B) give the kinetic parameters related to first-order and second-order models, respectively. The rate constant K₁, and Qe (Qe1 and Qe2 denotes calculated Qe from the first-order and second-order kinetic plots respectively) for MK10_PEI-Cu-NPs, were K1=0.0993 min-1, Qe1=0.1977 mg g-1 [from plot] and r2=0.7771; and K2=1.7957 g mg-1 min-1, Qe2=24.8757 mg g-1 and r2=0.9999. For sand_PEI-Cu-NPs, K1=0.1168 min-1, Qe1=0.7318 mg g-1 and r2=0.7794; K2=0.8133 g mg-1 min-1, Qe2=24.8756 mg g-1 and r2=0.9999. Higher regression coefficients indicate that the degradation data are consistent with the second-order model.

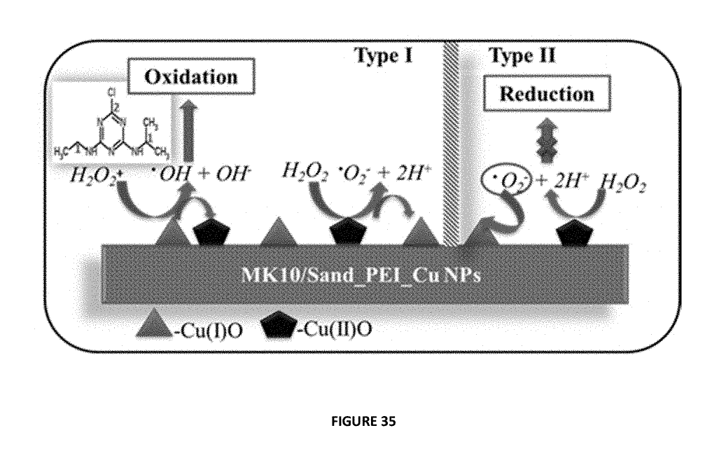

The second order mechanism indicates that the degradation rate depends not only on the atrazine concentration, but also on several additional parameters, including the external surface area of the MK10_PEI-Cu-NPs and sand_PEI-Cu-NPs, the shape and density of the particles, the concentration of the atrazine, steric hindrance due to bulkier PEI, and the mixing rate. Based on a previously reported atrazine degradation pathway (Colombini, M. P., Fuoco, R., Giannarelli, S., Pospisil, L. & Trskova, R. Protonation and Degradation Reactions ofs-Triazine Herbicides. Microchem J. 59, 239-245 (1998)), the following possible mechanism of degradation is suggested (and depicted in FIG. 35). The active sites in MK10_PEI-Cu-NPs and sand_PEI-Cu-NPs, which contain Cu₂O and CuO, are recognized as the redox-active species within the layers, pores, and outside surfaces. These Cu-NPs had high oxidation activity and were easily reducible, and thus function as reactive centers for oxidative degradation of atrazine and its degradation intermediates in the layers of montmorillonite and micropores of sand in the presence of hydrogen peroxide.

When the experiment was under acidic condition (pH<2), the degradation began with protonation of amino groups preceding electron transfer and de-alkylated products (Colombini, M. P., Fuoco, R., Giannarelli, S., Pospisil, L. & Trskova, R. Protonation and Degradation Reactions ofs-Triazine Herbicides. Microchem J. 59, 239-245 (1998)). At alkaline conditions (above pH 8), the degradation started from substitution of Cl atom by attack of an anionic hydroxyl group; this may boost the possible production of OH radicals during degradation. In conclusion, at circumneutral pH, oxidation of the alkyl groups of the amines produced a hydroxyl group that leads to degradation (Mami án, M. Torres, W. & Larmat, F. E. Electrochemical Degradation of Atrazine in Aqueous Solution at a Platinum Electrode. Portugaliae Electrochimica Acta 27, 371-379 (2009), Chen, C. et. al. Photolytic destruction of endocrine disruptor atrazine in aqueous solution under UV irradiation: products and pathways. J Hazard Mater. 172, 675-684 (2009)).

In all of the above cases, copper is the active site and responsible for the high reactivity attributed to the unique dimeric Cu species (e.g., Cu2+-O2−-Cu2+, Cu+-O2−-Cu2+, and Cu+ . . . Cu2+-O (Deka, U., Lezcano-Gonzalez, I., Weckhuysen, B. M. & Beale, A. M. Local Environment and Nature of Cu Active Sites in Zeolite-Based Catalysts for the Selective Catalytic Reduction of NOₓ. ACS Catal. 3, 413-427 (2013), Smeets, P. J., Groothaert, M. H. & Schoonheydt, R. A. Cu based zeolites: A UV-vis study of the active site in the selective methane oxidation at low temperatures. Catal Today 110, 303-309 (2005), Llabrés i Xamena, F. X. et. al. Thermal Reduction of Cu2+-Mordenite and Re-oxidation upon Interaction with H2O, O2, and NO. J Phys Chem B 107, 7036-7044 (2003)). The entire transition is stabilized by the host (MK10 or sand) and PEI.

When Cu²⁺ is the active center, it is anticipated that electrons can be transferred from the oxygen to the metal cations and the total charge is equilibrated/stabilized from the neighboring amine functional group containing loan pair of electron as well as from host during the degradation. As noted above (Example 3), EPR experimental results for the degradation of atrazine with PEI-Cu-NPs, the degradation mechanisms involves OH radicals, not peroxo radicals at circumneutral pH (Nasreen A. Montmorillonite. Synlett. 8, 1341-1342 (2001)).

FIG. 35 suggests possible mechanism, where the PEI and host matrix stabilize the transition states for re-oxidation of copper species; this in turn closes the catalytic cycle. MK10 was used as an efficient and versatile catalyst for various organic reactions such as synthesis of dimethyl acetals, enamines, γ-lactones, enolthioethers, α, β-unsaturated aldehydes and porphyrin synthesis (Kalidhasan, S. et. al. Oxidation of aqueous organic pollutants using a stable copper nanoparticle suspension. Can J Chem Eng. 9999, 1-10 (2016)). The interlayer cations are exchangeable, thus allowing alteration of the acidic nature of the material by a simple ion-exchange procedure (Zhou, C., Li, X., Li, Q. & Tong, D. Synthesis and acid catalysis of nanoporous silica/alumina-clay composites. Catal Today 93-95, 607-613 (2004)).

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A degradation composite comprising reduced copper(II)-based nanoparticles coordinated to a polymer forming a complex (Cu-NPs), wherein said polymer is an amino based polymer.

2. The composite of claim 1, wherein said polymer is polyethylenimine and said composite comprises reduced Cu(II)-polyethylenimine complex.

3. The composite of claim 2, wherein said reduced copper(II)-based nanoparticles (Cu-NPs) comprise between 10% and 90% of polyethylenimine by weight.

4. The composite of claim 2, wherein the diameter of said reduced copper (II)-based nanoparticles (Cu-NPs) is between 2 nm to 300 nm.

5. The composite of claim 1, wherein said reduced copper(II)-based nanoparticle comprises copper species of Cu(I), Cu₂O, Cu(II), CuO, Cu(O), dimeric Cu species or combination thereof.

6. The composite of claim 5, wherein said dimeric Cu species is Cu²⁺—O²— Cu²⁺, Cu⁺—O²⁻—Cu²⁺, or Cu⁺ . . . Cu²⁺—O.

7. The composite of claim 1, wherein said composite is prepared by mixing amino based polymer with a Cu(II) salt followed by addition of a reducing agent, and formation of reduced copper based nanoparticles.

8. The composite of claim 7, wherein said reducing agent is NaBH₄.

9. The composite according to claim 1, wherein said composite further comprises a silica based material and said Cu-NPs are incorporated into said silica based material.

10. The composite of claim 9, wherein said silica based material comprises clay, sand or zeolite or combination thereof.

11. The composite of claim 10, wherein said clay is MK10.

12. A method of degrading organic pollutants wherein said method comprises contacting a pollutant and a degradation composite comprising reduced copper(II)-based nanoparticle coordinated to a polymer forming a complex (Cu-NPs), wherein said polymer is an amino based polymer, in the presence of an oxidant.

13. The method of claim 12, wherein said amino based polymer is polyethylenimine and said composite comprise reduced Cu(II)-polyethylenimine complex.

14. The method of claim 12, wherein said degradation composite, further comprising a silica based material and said Cu-NPs are incorporated into said silica based material.

15. The method of claim 14, wherein said silica based material comprises clay, sand, zeolite or combination thereof.

16. The method of claim 15 wherein said clay is MK10.

17. The method of claim 12, wherein said method is in aqueous solution.

18. The method of claim 12, wherein said oxidant is a peroxide, a chromate, a chlorate, ozone, a perchlorate, an electron acceptor, or any combination thereof.

19. The method of claim 18, wherein said oxidant is ozone or hydrogen peroxide.

20. The method of claim 18, wherein the concentration of the oxidant in said solution is between 0.0005%-10% w/v.

21. The method of claim 17, wherein the concentration of said reduced copper(II) based nanoparticles complex (Cu-NPs) in said solution is at least 0.15 mM.

22. The method of claim 17, wherein the concentration of said reduced copper(II) based nanoparticles complex (Cu-NPs) in said solution is between 0.15 mM to 1 mM.

23. The method of claim 13, wherein said reduced copper(II)-based nanoparticles complex (Cu-NPs) comprise between 10% and 90% of polyethylenimine by weight.

24. The method of claim 12, wherein the diameter of said reduced copper(II)-based nanoparticles complex (Cu-NPs) is between 2 nm to 300 nm.

25. The method of claim 13, wherein said reduced Cu(II)-polyethylenimine complex comprises Cu(II), CuO, Cu(I), Cu₂O, elementary copper (Cu⁰), dimeric Cu species or combination thereof.

26. The method of claim 25, wherein said dimeric Cu species is Cu²⁺—O²—Cu²⁺, Cu⁺—O²—Cu²⁺, or Cu⁺ . . . Cu²⁺—O.

27. The method of claim 13, wherein said reduced Cu(II)-polyethylenimine complex does not comprise CuO.

28. The method of claim 13, wherein said reduced Cu(II)-polyethylenimine complex comprises Cu₂O, CuO, elementary copper (Cu⁰), less than 15% by weight of CuO or combination thereof.

29. The method of claim 12, wherein said method is conducted under aerobic conditions and is for a period of time sufficient to oxidize said pollutant and thereby said pollutant degrades.

30. The method of claim 28, wherein said pollutant degrades by 80-100%.

31. The method of claim 12, wherein said organic pollutant comprises chemical contaminant, a biological contaminant, a wastewater, a hydrocarbon, an industrial effluent, a municipal or domestic effluent, an agrochemical, an herbicide, a pharmaceutical or any combination thereof.

32. The method of claim 17, wherein a salt is added to said solution.

33. The method of claim 32, wherein the salt is NaCl, wherein NaCl concentration is between 1 mM and 1M.

34. A degradation kit comprising:
(a.) an oxidizing agent; and (b.) a degradation composite comprising reduced Cu(II)-based nanoparticles wherein said reduced Cu(II)-based nanoparticles are coordinated to a polymer forming a complex (Cu-NPs), wherein said polymer is an amino based polymer.

35. The kit of claim 34, wherein said amino based polymer is polyethylenimine and said composite comprise reduced Cu(II)-polyethylenimine complex.

36. The kit of claim 34, wherein said degradation composite further comprising a silica based material.

37. The kit of claim 36, wherein said silica based material comprises sand, clay, zeolite or combination thereof.

38. The kit of claim 34, wherein said oxidizing agent is a peroxide or ozone.

39. The kit of claim 38, wherein said peroxide is hydrogen peroxide.

40. The kit of claim 34, wherein said nanoparticles have a diameter ranging from between 2 nm and 300 nm.

41. The kit of claim 35, wherein said reduced Cu(II)-polyethylenimine complex comprise CuO, Cu₂O, elementary copper(Cu⁰), Cu(I), Cu(II), dimeric Cu species or combination thereof.

42. The kit of claim 41, wherein said dimeric Cu species is Cu²⁺—O²⁻—Cu²⁺, Cu⁺—O²⁻—Cu²⁺, or Cu⁺ . . . Cu²⁺—O.

43. The kit of claim 35, wherein said reduced Cu(II)-polyethylenimine complex does not comprise CuO.

44. The kit of claim 35, wherein said reduced Cu(II)-polyethylenimine complex comprises Cu₂O, elementary copper(Cu⁰), less than 15% by weight of CuO or combination thereof.
